(19) United States
(12) Patent Application Publication
(10) Pub. No.: US 2010/0162140 A1
(43) Pub. Date: Jun. 24, 2010

(54) SYSTEMS AND METHODS FOR PROVIDING A GUIDE TO ON-LINE EVENTS

(75) Inventors: Edgar A. Fereira, Stamford, CT (US); Thomas L. Hagopian, New Canaan, CT (US); L. Joe Hedges, Tulsa, OK (US); Michael S. Leib, Great Neck, NY (US); Nicole A. Curling, New York, NY (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Tulsa, OK (US)

(21) Appl. No.: 12/603,139

(22) Filed: Oct. 21, 2009

Related U.S. Application Data
(63) Continuation of application No. 10/062,744, filed on Feb. 1, 2002, now abandoned.
(60) Provisional application No. 60/265,997, filed on Feb. 2, 2001.

(51) Int. Cl. G06F 3/048

(52) U.S. Cl. 715/760; 715/764

(57) ABSTRACT

Systems and methods for providing a guide to on-line content are provided. The guide may allow users to more easily find desirable on-line content such as on-line events. On-line events may include, for example, on-line events of formats such as chat sessions, simulchats, Webcasts, television programming enhancements, limited availability on-demand content, or any other suitable format of on-line event. The guide may provide users with the ability to filter listings for on-line events so that only listings of user-specified criteria are displayed. The guide may allow providers of on-line events to provide event information for use in providing on-line event listings or other guidance features.

### CROSS REFERENCE TO RELATED APPLICATION

This application claims the benefit of U.S. provisional patent application No. 60/265,997, filed Feb. 2, 2001.

### BACKGROUND OF THE INVENTION

The present invention relates to systems and methods for providing guidance for Internet-delivered content and, more particularly, to systems and methods for providing guidance for on-line events.

Interactive television program guides are one type of guidance application that enable television viewers to find and view television programs of interest. Interactive television program guides have been proposed and are available in a number of different architectures. For example, program guides are available that run wholly on set-top boxes. These types of guides, sometimes referred to as “stand-alone” guides, periodically download program guide data from a guide provider. Program guides have also been implemented on Web sites. Users access these guides, sometimes referred to as “on-line” guides, using a personal computer or other suitable device with an Internet connection.

With the advent of the Internet, consumers have access to a wide range of media. For example, users can access vast amounts of textual, graphical, video, and audio content offered by a virtually uncountable number of Web sites. Recently, Internet-delivered content (sometimes referred to herein as “on-line content”) has realized an explosion in variety and quantity. For some users, searching for desired on-line content can be a frustrating and time-consuming experience, even with the aid of a search engine. For example, some Web addresses do not match the name of their owner, which may make initially navigating to a desired Web site difficult for some users. As another example, some may find it difficult to formulate searches that return desirable Internet-delivered content without returning a large number of undesirable “hits.” Finding and accessing on-line events such as chat sessions may be even more difficult for some users because such events may only be available for a limited time.

Accordingly, it would be desirable to provide a guidance application for Internet-delivered content that allows users to more easily find desirable Internet-delivered content such as on-line events.

### SUMMARY OF THE INVENTION

The present invention relates to systems and methods for providing guidance for on-line content such as on-line events. Illustrative features of various embodiments of the present invention are described, for example, in U.S. provisional patent application No. 60/265,997, filed Feb. 2, 2001, which is hereby incorporated by reference herein in its entirety.

As used herein, on-line events may be any scheduled Internet-delivered content that is associated with a real-time activity or activities. By way of illustration, and not of limitation, illustrative formats of on-line events include, for example, chat sessions, simulchats, Webcasts, television programming enhancements (sometimes referred to herein as “enhanced TV”), and on-demand content provided for limited times (such on-demand content is sometimes referred to herein as “limited availability on-demand content”).

The systems and methods of the present invention guide users in finding desired on-line events. In some embodiments, for example, users may access a Web page that includes a display of on-line event listings. The display may be sorted by time, event provider, or other suitable sort criteria. In some embodiments, the display may include a grid of on-line event listings having columns that correspond to different time slots, and rows that correspond to different providers of on-line events.

In some embodiments, the guidance application may provide users with the ability to filter listings for on-line events so that only listings for on-line events of user-specified formats are displayed. For example, the on-line guidance application may provide a user with the ability to view listings for only chat sessions. In some of these embodiments, the guidance application may also provide users with the ability to filter the listings so that only events of a specific category are displayed. For example, the guidance application may provide the user with the ability to filter the listings for event categories such as television, movies, music, news, sports, teens, books, health, technology, or any other suitable category of event.

In some embodiments, the guidance application may graphically indicate the provider or promoter of on-line events. The graphical indicator may be displayed in place of, or in addition to, a link (e.g., a universal resource locator (URL)) for the provider's or promoter's site. For example, the guidance application may provide a provider's brand as an indicator of a provider in listings displays.

Some embodiments may enable the provider or promoter of an on-line event to provide event information to the guidance application provider for use in providing on-line event listings or other guidance features. For example, the guidance application may receive a description of an on-line event for its provider. The description may include, for example, listings, event information, advertisements, descriptions, editorials, or other suitable information about the event.

### BRIEF DESCRIPTION OF THE DRAWINGS

Further features of the invention, its nature, and various advantages will become more apparent upon consideration of the following detailed description, taken in conjunction with the accompanying drawings, in which like reference characters refer to like parts throughout, and in which:

FIG. 1 is a diagram of an illustrative arrangement for an on-line guidance application system in accordance with one embodiment of the present invention;

FIG. 2 is a generalized diagram which may represent portions of the access devices of FIG. 1 in accordance with one embodiment of the present invention;

FIGS. 3-5 are portions of an illustrative initial display screen that may be provided by the guidance application in response to a user's request to access guidance for on-line events, in accordance with one embodiment of the present invention;

FIG. 6 is another illustrative arrangement for an initial display screen that may be provided by the guidance application in response to a user's request to access guidance for on-line events, in accordance with one embodiment of the present invention;

FIGS. 7-8 are portions of an illustrative event listings display screen that may be provided by the guidance application in accordance with one embodiment of the present invention;

FIG. 9 is another illustrative arrangement for an event listings display screen that may be provided by the guidance application in accordance with one embodiment of the present invention;

FIG. 10 shows an illustrative event information overlay in accordance with one embodiment of the present invention;

FIGS. 11-17 show portions of illustrative displays that allow users to filter listings for on-line events, in accordance with various embodiments of the present invention;

FIG. 18 shows a portion of an illustrative editorial content display screen that may be provided by the guidance application in accordance with one embodiment of the present invention;

FIG. 19 shows a portion of an illustrative Web watch display screen that may be provided by the guidance application in accordance with one embodiment of the present invention;

FIG. 20 shows the Web watch display screen of FIG. 19 with an expanded Web watch list in accordance with one embodiment of the present invention;

FIG. 21 shows an illustrative login overlay that may be provided by the guidance application to a provider of on-line event information, in accordance with one embodiment of the present invention;

FIG. 22 shows an illustrative event listings review display screen that may be provided by the on-line guidance application after the provider of on-line event information has logged into the guidance application, in accordance with one embodiment of the present invention;

FIG. 23 shows an illustrative information entry overlay that may be provided by the guidance application in accordance with one embodiment of the present invention;

FIG. 24 shows an illustrative provider grid display screen that may be provided by the guidance application in accordance with one embodiment of the present invention;

FIG. 25 shows another illustrative provider grid display screen that may be provided by the guidance application in accordance with one embodiment of the present invention;

FIG. 26 shows an illustrative all-providers grid display screen that may be provided by the guidance application in accordance with one embodiment of the present invention;

FIG. 27 shows another illustrative all-providers grid display screen that may be provided by the guidance application in accordance with one embodiment of the present invention;

FIG. 28 is a flow chart of illustrative steps involved in providing filtered listings in accordance with one embodiment of the present invention;

FIG. 29 shows a flow chart of illustrative steps involved in providing listings for on-line events filtered by format and category, in accordance with one embodiment of the present invention;

FIG. 30 is a flow chart of illustrative steps involved in receiving on-line event information in accordance with one embodiment of the present invention; and

FIG. 31 is a flow chart of additional illustrative steps involved in receiving on-line event information in accordance with one embodiment of the present invention.

### DETAILED DESCRIPTION OF EMBODIMENTS OF THE INVENTION

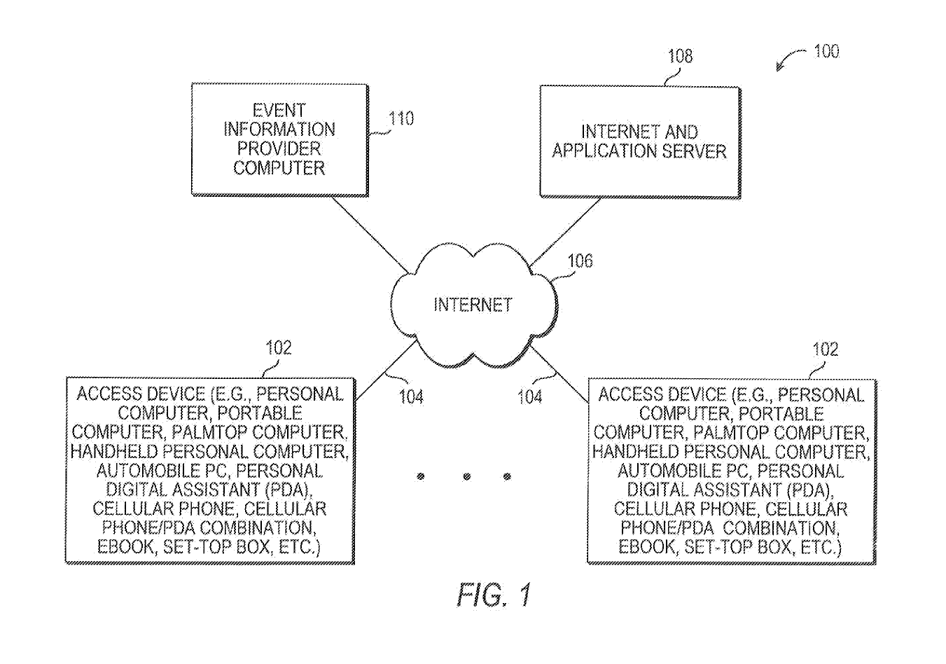

FIG. 1 shows an illustrative arrangement for guidance application system 100 in accordance with one embodiment of the present invention. For purposes of clarity, and not by way of limitation, features of the present invention will be described as provided by an on-line guidance application. In practice, the guidance features of the present invention may be provided using other guidance application architectures.

Access devices 102 may be connected via links 104 to Internet 106. Access devices 102 may include any device or combination of devices suitable for providing Internet access to a user of system 100. Access devices 102 may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, ebook, set-top box (e.g., a Web-enabled set-top box), or other device suitable for providing Internet access. In practice, there may be many access devices 102, but only two have been shown to avoid overcomplicating the drawing.

Internet and application server 108 may be any server suitable for providing access to the on-line guidance application. Internet and application server 108 may, for example, provide the on-line guidance application to access devices 102 using one or more suitable protocols (e.g., the HyperText Transfer Protocol (HTTP) and Transmission Control Protocol/Internet Protocol (TCP/IP)). On-line guidance application pages may be defined using, for example, any suitable markup language (e.g., HyperText Markup Language (HTML), Dynamic HyperText Markup Language (DHTML), Extensible Markup Language (XML), JavaServer Pages (JSP), Active Server Pages (ASP), or any other suitable approaches). The pages may include scripts, computer code, or subsets of computer code that define mini-programs (e.g., Perl scripts, Java applets, Enterprise JavaBeans (EJB), or any other suitable approaches). The on-line guidance application may be designed using modular approaches such as, for example, Java 2 Platform Enterprise Edition (J2EE), Component Object Model (COM), Distributed Component Object Model (DCOM), or any other suitable approach. In practice, features of Internet and application server 108 may be integrated into a single server as shown, or may be distributed across multiple servers that are interconnected via Internet 106 or another communications network (e.g., an Ethernet LAN).

In some embodiments, Internet and application server 108 may also provide on-line content such as text, graphics, video, audio, Web pages, applications, and on-line events. On-line content may be provided using, for example, those approaches used to provide the on-line guidance application. Some embodiments may provide content, or access to on-line content, within displays of the on-line guidance application.

Links 104 may include any transmission medium suitable for providing Internet access to access devices 102. Links 104 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or combination of such links. Links 104 may be of different types depending on, for example, the particular type of access devices 102 to which the link is connected.

Any protocol or protocol stack suitable for supporting communications between access devices 102 and Internet and application server 108 over links 104 may be used. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of such protocols may be used.

Event information provider computer 110 may be any computer-based system suitable for providing information associated with on-line events (sometimes referred to herein as “event information”) to Internet and application server 108. Event information provider computer 110 may include, for example, a computer or network of computers that allow system operators to enter event information, such as event listings information (e.g., titles and times), event descriptions, advertisements (e.g., text, graphics, video, or audio that advertises or promotes events, or links thereto), editorial information, or any other information associated with an event. In practice there may be multiple event information provider computers 110, but only one has been drawn to avoid over-complicating the drawing. Event information provider computer 110 may be run by, for example, the provider of an event (e.g., a Web site provider) or the promoter of an event. In some embodiments, event information may be generated by the guidance application provider. In such embodiments, the features of event information provider computer 110 and Internet and application server 108 may be provided by a single system.

Event information provider computer 110 may include equipment suitable for providing event information to Internet and application server 108 over Internet 106 or over another link (not shown). Event information provider computer 110 may provide event information to Internet and application server 108 in response to requests from Internet and application server 108, or may provide the event information automatically using any suitable frequency (e.g., as the information becomes available, once per hour, once per day, or any other suitable frequency). Event information provider computer 110 may provide the event information as, for example, files using the file transfer protocol (FTP), a data stream over a socket, text in an e-mail, using post functions (such as when a user enters data into an HTML document, for example), or using any other suitable approach.

In embodiments involving platforms other than personal computers, modified versions of guide displays may be used. For example, content for on-line guidance application displays may be formatted or stripped from displays by Internet and application server 108 to make the displays appropriate for access device 102 that are not personal computers. Alternatively, different Web pages may be constructed by Internet and application server 108 depending on a user's access device 102.

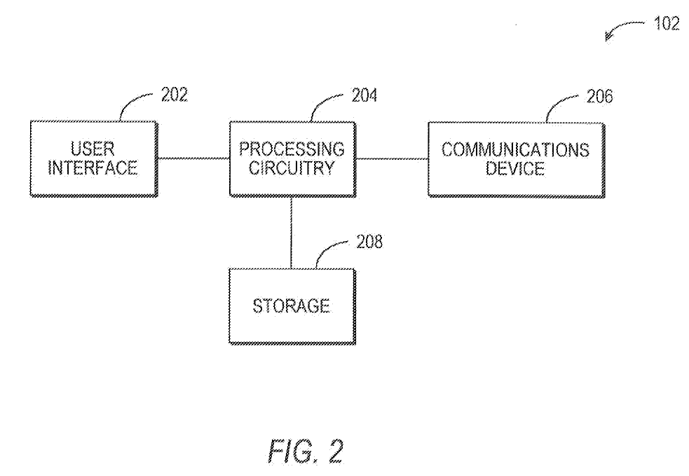

FIG. 2 shows a generalized diagram which may represent portions of an access device 102 of FIG. 1 in accordance with one embodiment of the present invention. Access device 102 may have, for example, user interface 202, processing circuitry 204, communications device 206, and storage 208. User interface 202 may include any suitable combination of input and output devices. User interface 202 may include, for example, a pointing device, keyboard, touch-pad, touch screen, pen stylus, voice recognition system, mouse, trackball, cathode ray tube (CRT) monitor, liquid crystal display (LCD), voice synthesis processor and speaker, or any other suitable user input or output device. Processing circuitry 204 may include any suitable processor, such as an Intel Pentium® microprocessor or group of processors, and other suitable circuitry (e.g., input/output (I/O) circuitry, direct memory access (DMA) circuitry, etc.). Communications device 206 may be any device suitable for supporting communications over links 104 (FIG. 1). Communications device 206 may include, for example, a modem (e.g., any suitable analog or digital standard, cable, or cellular modem), a network interface card (e.g., an Ethernet card, token group card, etc.), a wireless transceiver (e.g., an infrared, radio, or other suitable analog or digital transceiver), or other suitable communications devices. Storage 208 may be any suitable memory, storage device, or combination thereof, such as RAM, ROM, flash memory, a hard disk drive, microdrive, floppy disk, or other suitable storage device or media.

In embodiments employing the arrangement of system 100 of FIG. 1, access device 102 and the guidance application may interact as follows. Users interact with guidance application displays using user interface 202. User commands are provided to processing circuitry 204 by user interface 202 for processing. Processing circuitry 204 may format some commands as requests and direct communications device 206 to provide the request to the guidance application over Internet 106 (FIG. 1). The guidance application processes the request and returns the result to communications device 206. Processing circuitry 204 receives the result from communications device 206, processes it (e.g., generates an appropriate display having the result), and directs user interface 202 to output the result. In some instances, processing circuitry 204 may store the result, or portions of the result, in storage 208.

For example, the user may indicate a desire to access a display of on-line event listings. In response, the guidance application may generate an HTML Web page that includes the listings. If desired, the Web page may include other content that may be associated with on-line events, such as advertisements for on-line events, descriptions of on-line events, editorials of on-line events, or any other suitable information. Communications device 206 receives the pages and provides them to processing circuitry 204. Processing circuitry 204, which may be running, for example, instructions from a Web-browser application retrieved from storage 208, generates or defines a display as defined by the Web page, and directs user interface 202 to display the page with the listings and other information.

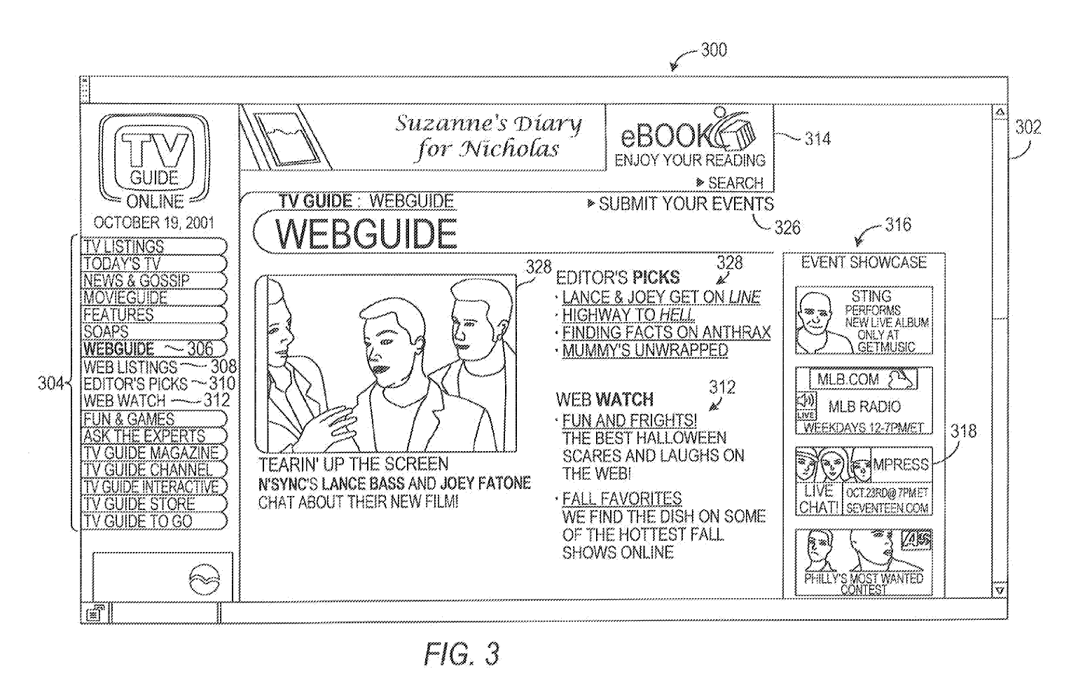

FIGS. 3-27 show illustrative display screens (e.g., Web pages), or portions of display screens, for providing guidance for on-line delivered content in accordance with various embodiments of the present invention. The display screens of FIGS. 3-27 are merely illustrative. Any other suitable user interface elements for providing the features therein may be used. For example, selectable areas, buttons, drop-down lists, fields for entering text, and any other user interface elements may be interchanged with the elements shown in the various figures to provide various features. In addition, the display screens of FIGS. 3-27 are described herein as being “provided” by the guidance application. This is intended to include any suitable approach for generating displays that include event information received over the Internet from a remote source, such as Internet and application server 108 (FIG. 1). This may include, for example, mark-up language-based approaches where a Web browser running on access device 102 (FIG. 1) is used to interface with the guidance application, approaches where displays are remotely generated and downloaded for direct display, or any other suitable approach.

FIGS. 3-5 show portions of an illustrative initial display screen 300 that may be provided by the on-line guidance application in accordance with one embodiment of the present invention. The on-line guidance application may provide initial display screen 300 to a user in response to receiving a user's request to access the guide. Each of FIGS. 3-5 shows portions of initial display screen 300 as it may be displayed in response to a user positioning scroll bar 302. This is indicated by the different positions of scroll bar 302 in each of FIGS. 3-5.

Initial display screen 300 may include menu region 304. Menu region 304 may be included in one or more other display screens of the on-line guide. Menu region 304 may include selectable options to access on-line content provided by the on-line guidance application. For example, such content may be entertainment-related. Various examples of selectable options are shown in menu region 304.

In response to a user's selection of options such as TV Listings and Today's TV, the on-line guidance application may provide, for example, on-line content and features related to television programming. In response to a user's selection of News & Gossip, the on-line guidance application may provide, for example, on-line content related to entertainment news. In response to a user's selection of Features, the on-line guidance application may provide, for example, on-line content related to editorial features. In response to a user's selection of Soaps, the on-line guidance application may provide, for example, on-line content related to television soap operas. In response to a user's selection of Ask the Experts, the on-line guidance application may provide, for example, on-line content that includes questions and answers to entertainment-related topics. In response to a user's selection of TV Guide Magazine, TV Guide Channel, TV Guide Interactive, TV Guide Store, or TV Guide To Go, the on-line guidance application may provide, for example, on-line content related to other products or features provided by the provider of the on-line guidance application.

In the example of FIGS. 3-5, WebGuide option 306 is highlighted, indicating that the user has accessed the guide for on-line content. When WebGuide option 306 is highlighted, further selectable sub-options such as Web Listings option 308, Editor's Picks option 310, and Web Watch option 312 are revealed. For clarity, these features will be discussed below.

Display screen 300 may include one or more interactive advertisements 314. In response to a user's selection of an advertisement 314, the on-line guidance application may provide the user with a display screen that includes information in connection with the selected advertisement. For example, the on-line guidance application may provide the user with access to the Web site for a company such as “eBook,” in response to the user selecting eBook's advertisement.

Display screen 300 may include event showcase region 316. Event showcase region 316 may include selectable options that allow users to access various on-line events or information related to on-line events. In some embodiments, a provider of an on-line event may pay the provider of the on-line guidance application to include a link to the provider's on-line event in event showcase region 316. For example, in response to a user's selection of a link in event showcase region 316, such as link 318 for a chat session with the music group Mpress, the on-line guidance application may provide the user with access to the on-line chat session.

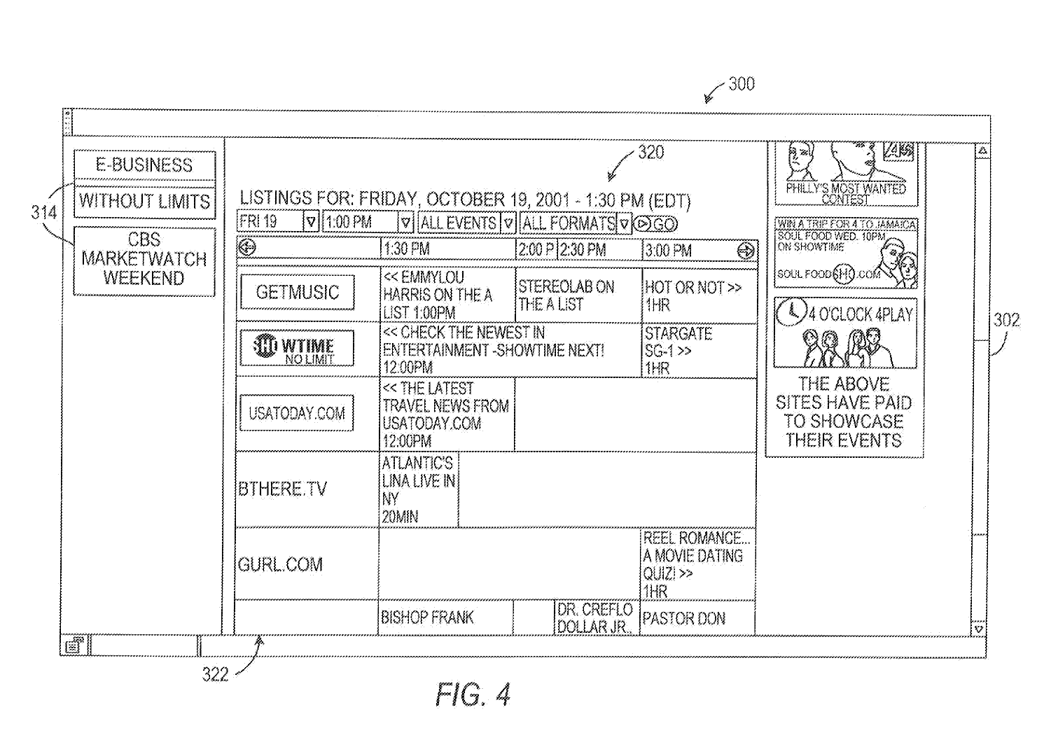

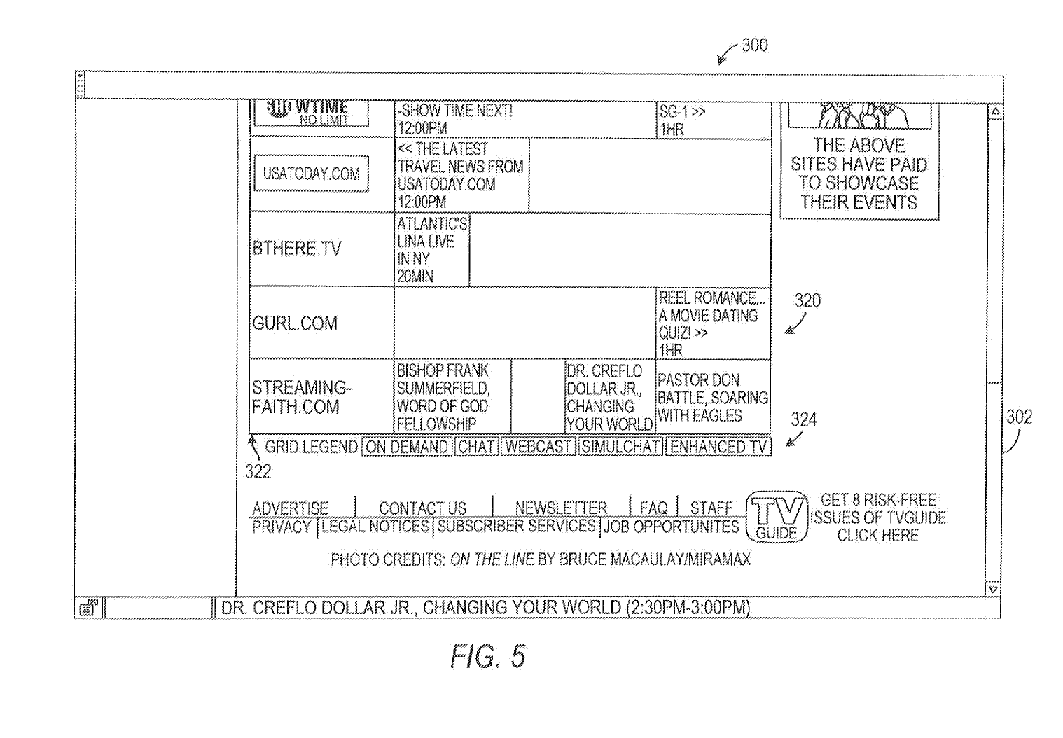

Display screen 300 may include listings area 320 (FIGS. 4-5). In this example, listings area 320 includes listings for only on-line events. In other approaches, listings area 320 may include listings for other content, such as television programs. The left-most column 322 of listings area 320 indicates event providers who have events indicated in listings area 320. Event listings are indicated adjacent to their providers (i.e., in the same row) in columns corresponding to the time of the events. In some embodiments, the listings for on-line events provided in listings area 320 may be color-coded. The color-coded feature of listings area 320 may function as a visual filter for the on-line event listings. Legend 324 (FIG. 5) may indicate which color applies to which format of on-line event. Various other features of listings areas, such as listings area 320, will be discussed below.

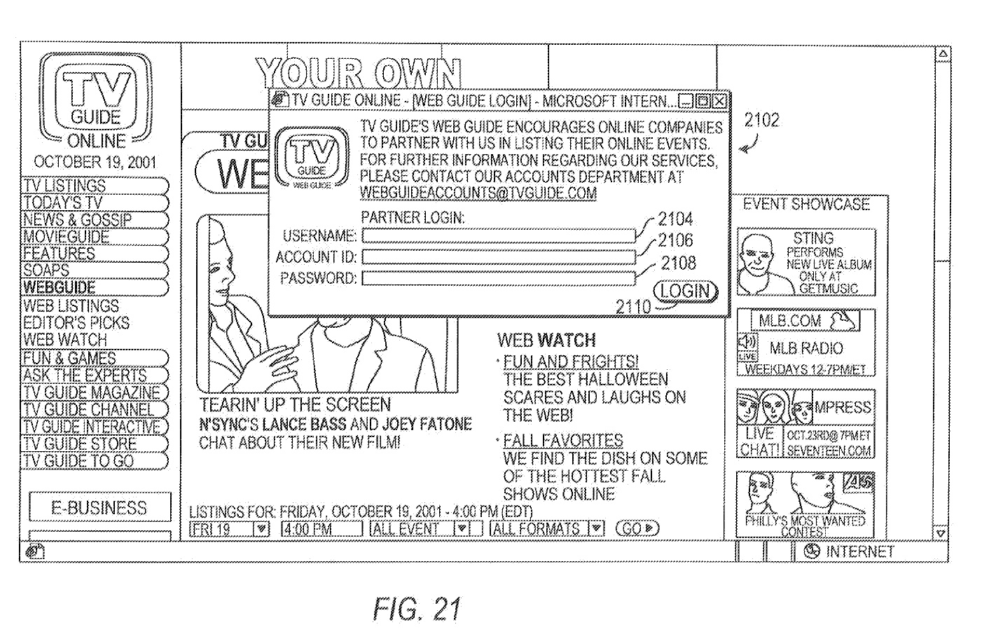

Initial display 300 may include Submit Your Events feature 326. In response to a user selecting Submit Your Events feature 326, the guide may provide displays that allow the user to enter information for on-line events. This information may be used by the guide to provide event listings and other guidance features related to on-line events. Submit Your Events feature 326, and illustrative displays therefor, are discussed below in connection with FIGS. 21-27.

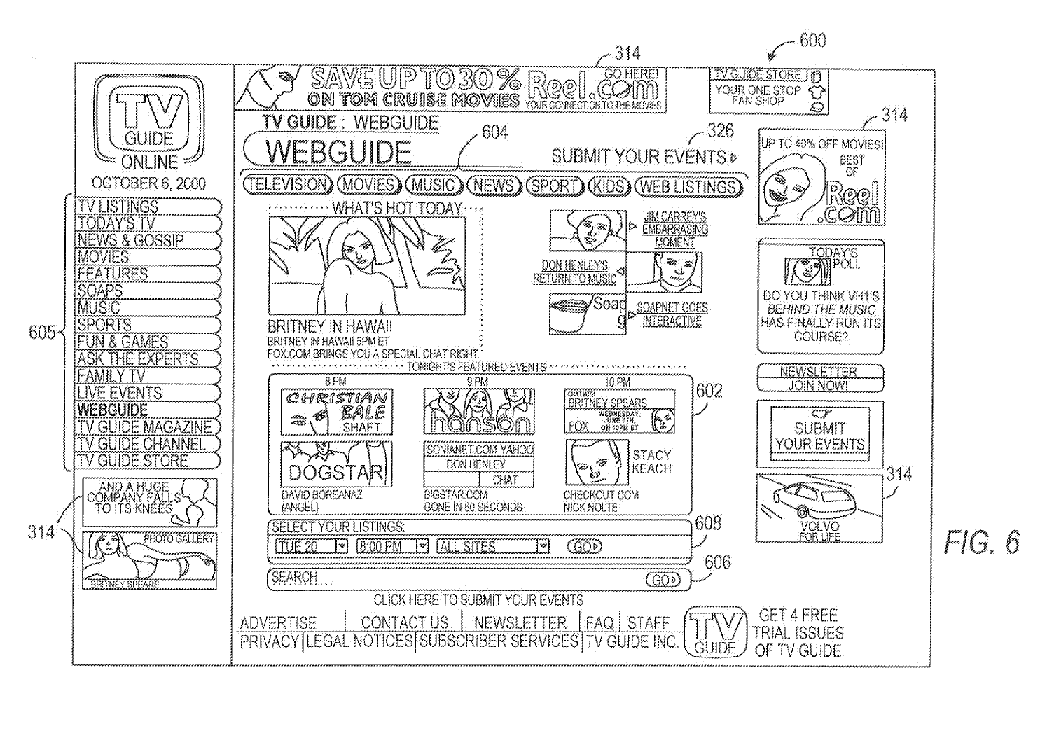

Another illustrative arrangement for an initial display screen is shown in FIG. 6. Similar to initial display screen 300, display screen 600 may include various selectable advertisements 314 and Submit Your Events feature 326. Advertising panel 602 may be similar to event showcase 316 (FIGS. 3-5) in that it may include paid-for advertisements of events.

Initial display screen 600 may provide the user with selectable event categories 604. In response to the user selecting a category 604, the guide may limit the features and information of its initial display 600 to features and information associated with on-line events of the selected category. This may provide the user with an easy way to filter the type of features and information presented to the user in an initial display. Initial display 600 may have menu 605 which in this example is similar to menu 304 of initial display 300 (FIG. 3).

Display screen 600 may include search feature 606. Search feature 606 enables the user to search for on-line events using, for example, keywords related to the desired on-line event. Display screen 600 may also include Select Your Listings feature 608. Select Your Listings feature 608 may allow users to select, for example, a date, time, and a Web site. In response, the on-line guidance application may provide the user with listings for events provided by the selected Web site at the specified date and time.

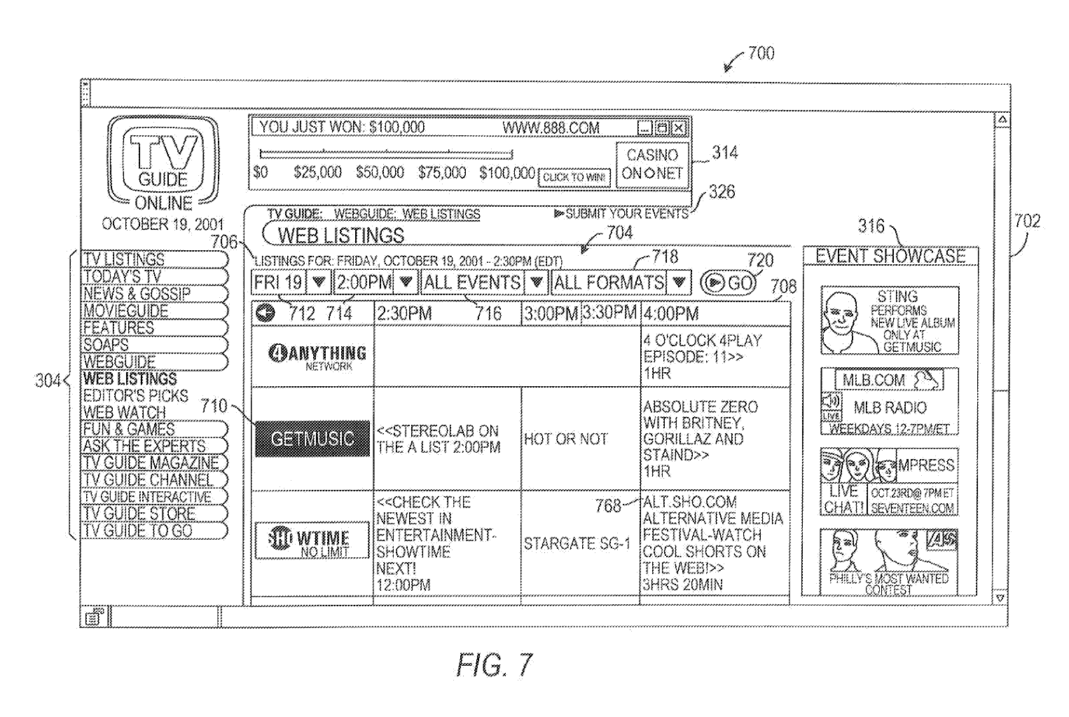

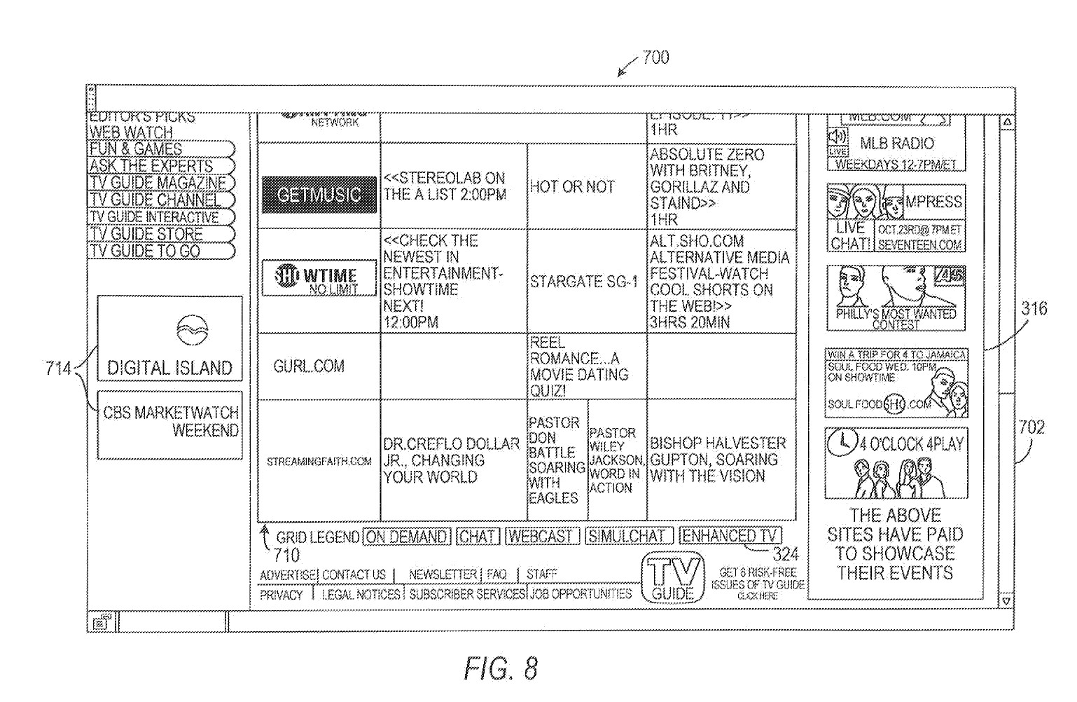

FIGS. 7-8 show portions of illustrative event listings display screen 700 that may be provided by the on-line guidance application in accordance with one embodiment of the present invention. Each of FIGS. 7-8 shows portions of listings display screen 700 as it may be displayed in response to a user positioning scroll bar 702. This is indicated by the different positions of scroll bar 702 in each of FIGS. 7-8.

Listings display screen 700 of FIGS. 7-8 has display characteristics and features similar to those of initial display screen 300 of FIGS. 3-5. For example, listings display screen 700 also includes menu region 304, interactive advertisements 314, event showcase 316, legend 324, and Submit Your Events feature 326. Accordingly, it may be most appropriate to provide listings display screen 700 in embodiments that use initial display screen 300 of FIGS. 3-5. For example, the on-line guidance application may provide listings display screen 700 in response to a user's selection of Web Listings option 308 of FIG. 3. In other embodiments, the on-line guidance application may provide listings display screen 700 in response to user interactions with listings area 320 of FIGS. 3-5, such as when a user selects a listing. In other embodiments, listings display screen 700 may be provided in response to a user selecting listings using Select Your Listings feature 608 of FIG. 6.

Listings area 704 may provide the user with listings for on-line events. The listings may include for example, event titles, durations, descriptions, or any other suitable information related to on-line events. Listings information region 706 of listings area 704 provides a user with a description of the displayed listings. For example, listings information region 706 may include the day and time that applies to the currently-displayed listings. Header portion 708 indicates the times (e.g., 2:30 PM, 3:00 PM, 3:30 PM, and 4:00 PM) of events shown. Initial column 710 indicates various providers of on-line events (e.g., 4Anything Network, GetMusic, Showtime, etc.). The listings for events of the providers of initial column 710 are provided adjacent to the providers (i.e., in the same row) in columns corresponding to the time of the events.

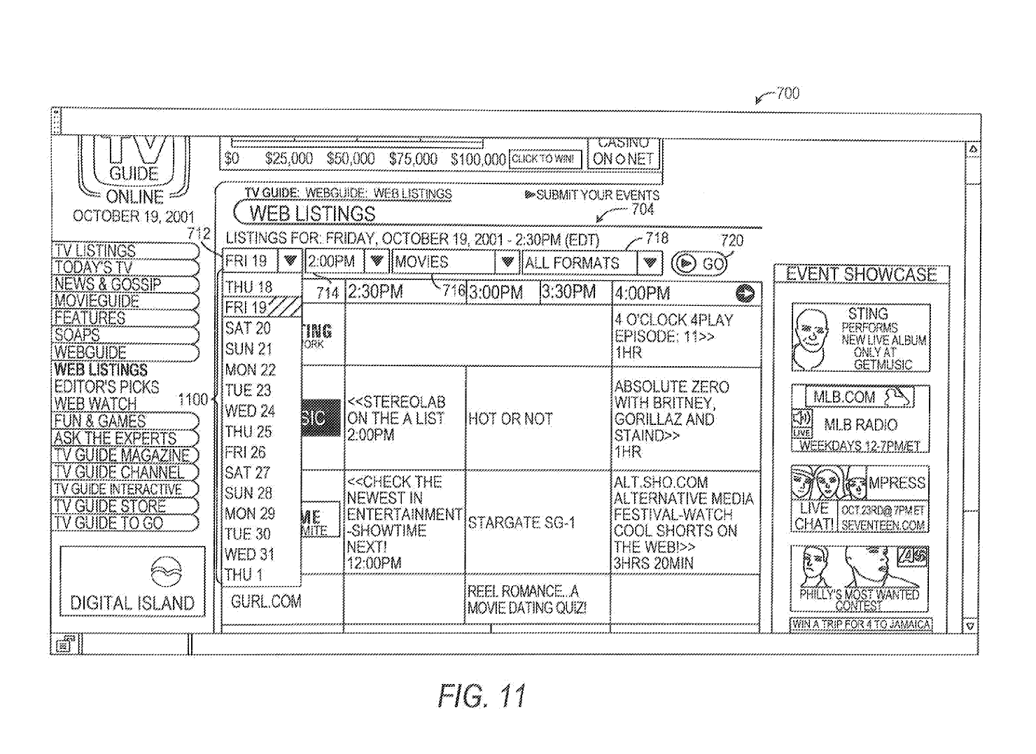

Listings area 704 may provide the user with the ability to select a day, a time, a format, and a category with which to filter the on-line event listings. These parameters may be selected using drop-down lists such as day list 712, time list 714, category list 716, and format list 718. In response to the user's selection of go option 720, the on-line guidance application may change listings area 704 to include only those listings that meet the parameter selections made by the user. For clarity, filtering on-line event listings will be discussed below in connection with FIGS. 11-17.

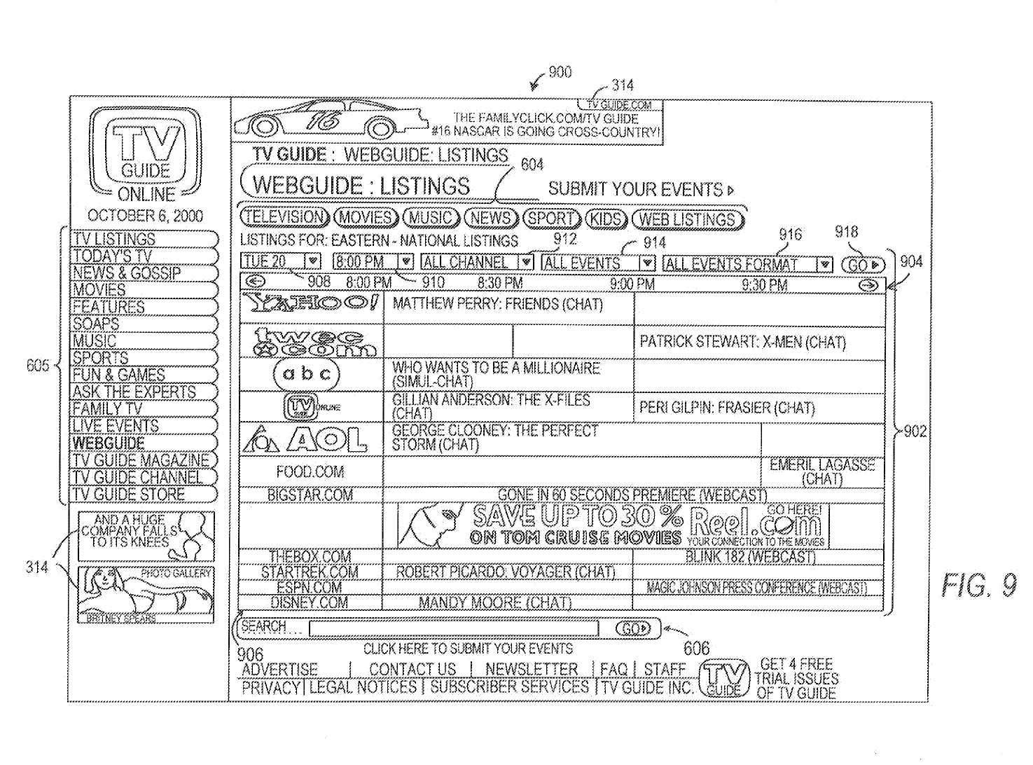

Another illustrative arrangement for a listings display screen is shown in FIG. 9. In this example, listings display screen 900 has display characteristics and features similar to those of initial display 600 of FIG. 6. For example, listings display screen 900 includes event categories 604, advertisements 314, menu 605, and search feature 606. Accordingly, it may be most appropriate to provide listings display screen 900 in embodiments that use initial display screen 600 of FIG. 6. For example, the on-line guidance application may provide listings display screen 900 in response to a user's interaction with Select Your Listings feature 608 of FIG. 6. In other embodiments, listings display screen 900 may be provided in response to a user interacting with listings area 320 of FIGS. 3-5.

Listings area 902 may provide the user with listings for on-line events. The listings may include for example, event titles, durations, descriptions, or any other suitable information related to an on-line event. Header portion 904 indicates the times (e.g., 8:00 PM, 8:30 PM, 9:00 PM, and 9:30 PM) of events shown. Initial column 906 indicates various providers of on-line events (e.g., Yahoo, twec.com, ABC, TV Guide OnLine, etc.). The listings for events of the providers of initial column 906 are provided adjacent to the providers (i.e., in the same row) in columns corresponding to the time of the events.

Listings area 902 may provide the user with the ability to select a day, a time, a format, and a category with which to filter the listings for on-line events. These parameters may be selected using drop-down lists such as day list 908, time list 910, channels list 912, category list 914, and format list 916. In response to the user's selection of go option 918, the on-line guidance application may change listings area 902 to include only those listings that meet the parameter selections made by the user. For clarity, filtering on-line event listings will be discussed below in connection with FIGS. 11-17.

In some embodiments the on-line guidance application may provide graphical identifiers of on-line event providers, such as the provider's brand, in listings areas such as listings area 320 of FIGS. 4-5, listings area 704 of FIGS. 7-8, and listings area 902 of FIG. 9. When providers of on-line events are sponsors of the online guidance applications (i.e., paid advertisers) such branding may be referred to as “partnership branding.” Branding in listings areas may allow users to more easily find online events for providers who, for example, do not have web addresses that match their names.

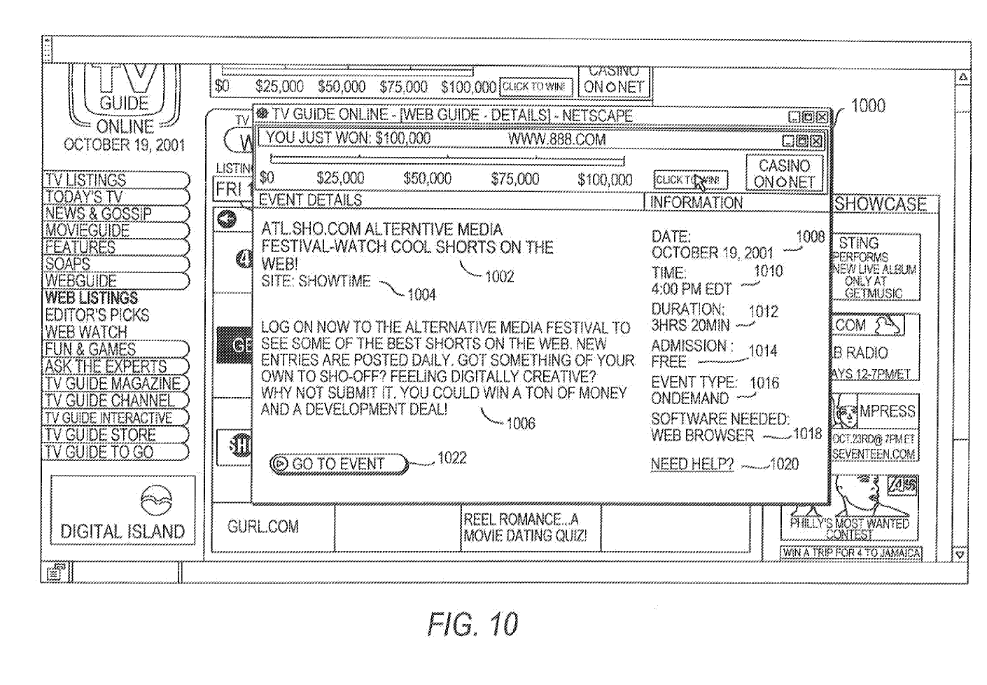

Some embodiments may supplement the information provided in listings areas, (such as listings area 320 of FIGS. 4-5, listings area 704 of FIGS. 7-8, or listings area 902 of FIG. 9) with additional event information. FIG. 10 shows an illustrative event information overlay 1000 in accordance with one embodiment of the present invention. The example of FIG. 10 shows additional information overlay 1000 overlaid onto listings display screen 700 of FIGS. 7-8. This is merely illustrative. Additional information overlay 1000 may be overlaid onto initial display screen 300 of FIGS. 3-5, initial display screen 600 of FIG. 6, listings display screen 900 of FIG. 9, or any other display screen that includes listings, indicators or other display items associated with on-line events.

The on-line guidance application may provide overlay 1000 in response to the user's selection of a listing, indicator, or other display item associated with an on-line event. For example, the guide may provide overlay 1000 in response to a user selecting an advertisement in event showcase 316 (FIGS. 3-5 and 7-8) or advertisement panel 602 (FIG. 6), or in response to a user selecting a listing from listing area 320 (FIGS. 3-5), listings area 704 (FIGS. 7-8), or listings area 902 (FIG. 9). In this example, the user has selected listing 768 of FIG. 7 for the on-line event provided by Showtime at 4:00 PM. Overlay 1000 may include information such as event title 1002, event location 1004 (e.g., the Web site Showtime.com), and event description 1006. Overlay 1000 may also include event date 1008 (e.g., Oct. 19, 2001), event time 1010 (e.g., 4:00 PM EDT), event duration 1012 (e.g., 3 hrs 20 min), event admission 1014 (e.g., free), event type 1016 (e.g., on-demand), and software needed 1018 (e.g., Web browser). Overlay 1000 may also include selectable help option 1020 that may provide the user with the ability to obtain answers to questions in connection with overlay 1000. In response to the user's selection of go button 1022, the on-line guidance application may provide the user with access to the on-line event.

In some embodiments, the on-line guidance application may enable users to filter on-line event listings to allow them to find on-line events of particular interest. For example, the on-line guidance application may provide users with the ability to filter the listings based on event format such as whether an event is a chat session, simulchat, Webcast, television programming enhancement (e.g., enhanced TV), limited availability on-demand content, or any other suitable format of event. In some embodiments, the on-line guidance application may enable users to further filter listings to find events of one or more user-specified categories. For example, the on-line guidance application may provide users with the ability to filter listings for event categories such as television, movies, music, news, sports, teens, books, health, technology, or any other suitable category of event.

FIGS. 11-17 show illustrative examples of how a user may use drop-down lists, such as drop-down lists 712, 714, 716, and 718 of FIGS. 7-8, to filter the on-line events provided in listings area 704 of FIGS. 7-8. It will be apparent from FIGS. 11-17 and the accompanying descriptions how the user may use similar drop-down lists 908, 910, 912, 914, 916 and 918 of FIG. 9 to filter the listings of listings area 902 of FIG. 9. The use of drop-down lists is merely illustrative. The on-line guidance application may provide filtering using any other suitable user interface approach, such as by providing a list of selectable parameters (e.g., using check boxes), by providing up and down arrows with which the user may scroll through and highlight parameters in a list, or any other suitable approach for providing the parameters. Also, these parameters are merely illustrative. The on-line guidance application may provide the user with the ability to filter the on-line event listings using any suitable parameters, such as provider of an event, the event's type, admission fee, software required to run an event, or any other suitable parameter.

FIG. 11 shows a portion of listings display screen 700 of FIG. 7 after a user has selected day list 712. In response to a user selecting day list 712, the on-line guidance application may provide list 1100 that contains the days of the month. The user may select a day of the month from list 1100 to set the day as a parameter with which the guide filters the on-line event listings in listings area 704. In this example, the user has selected “Fri 19” (i.e., Friday, October 19) from list 1100.

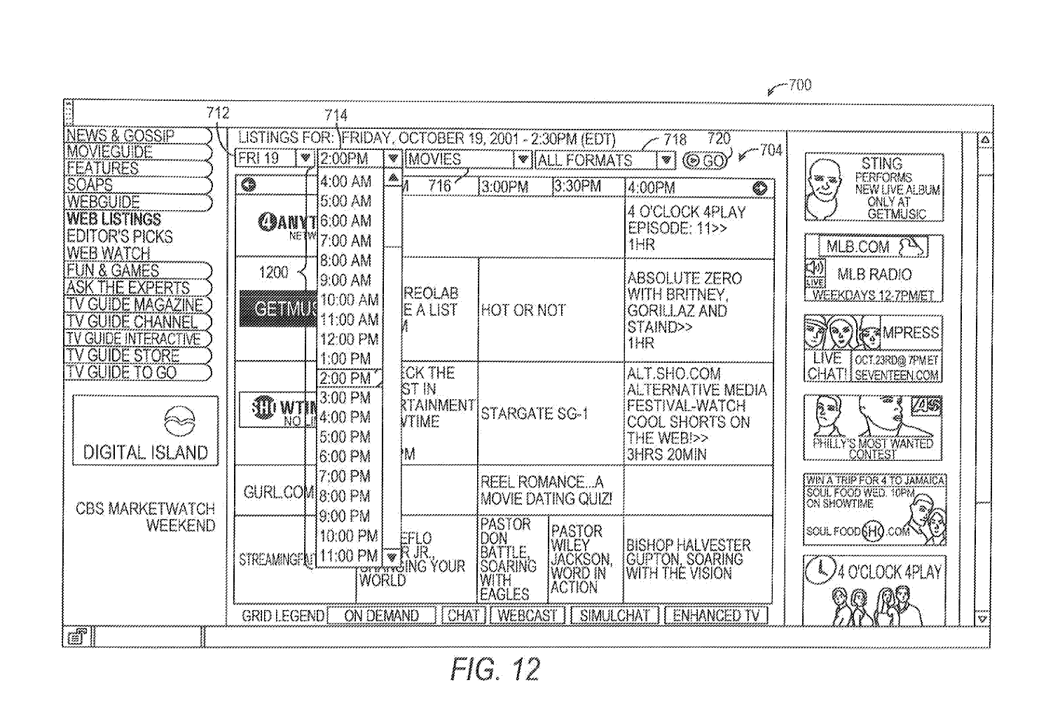

FIG. 12 shows a portion of listings display screen 700 of FIG. 7 after a user has selected time list 714. In response to a user selecting time list 714, the on-line guidance application may provide list 1200 that contains the hours of the day. The user may select a time of the day from list 1200 to set the time as a parameter with which the guide filters the on-line event listings in listings area 704. In this example, the user has selected “2:00 PM” from list 1200.

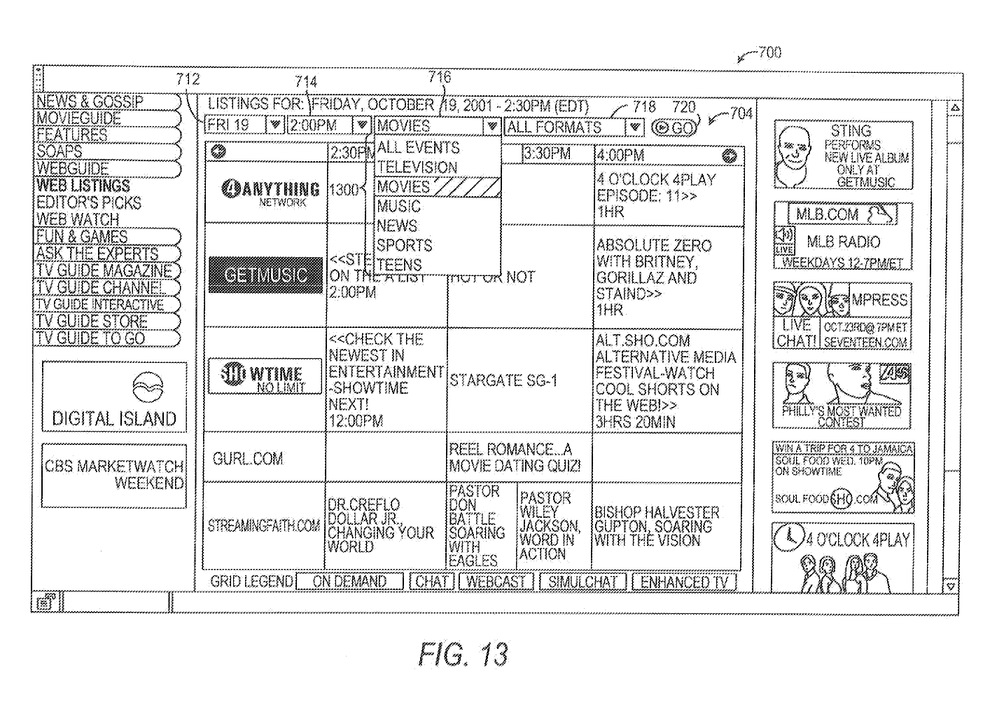

FIG. 13 shows a portion of listings display 700 of FIG. 7 after a user has selected category list 716. In response to a user selecting category list 716, the on-line guidance application may provide list 1300 that contains possible categories of on-line events. Possible categories may include, for example, all event categories, movies, music, news, sports, teens, books, health, technology, or any other suitable event category. The user may select a category from list 1300 to set the category as a parameter with which the guide filters the on-line event listings in listings area 704. In this example, the user has selected “movies” from list 1300.

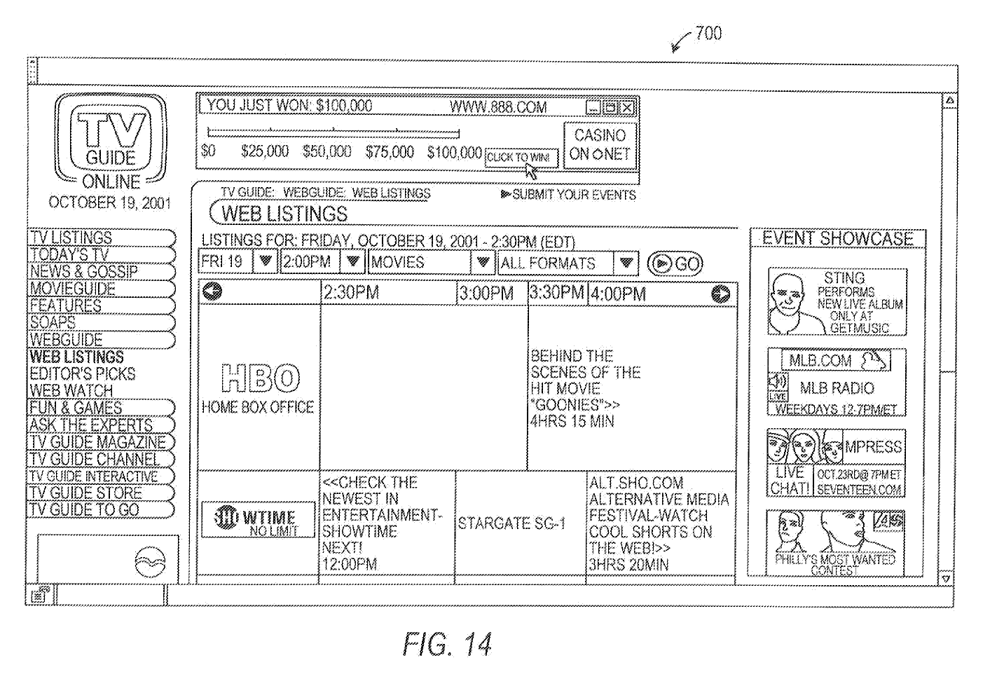

At this point in the example, the user has selected parameters to obtain listings for events of all formats, that are movies, and that are available starting at 2:00 PM on Friday, Oct. 19, 2001. The user may select go button 720 to filter the listings in listings area 704 based on the selected parameter or parameters. In response to the user submitting the parameters by selecting go option 720, the guide may filter the listings accordingly. FIG. 14 shows listings display screen 700 with listings for on-line events filtered according to the parameters that have been selected at this point in the example.

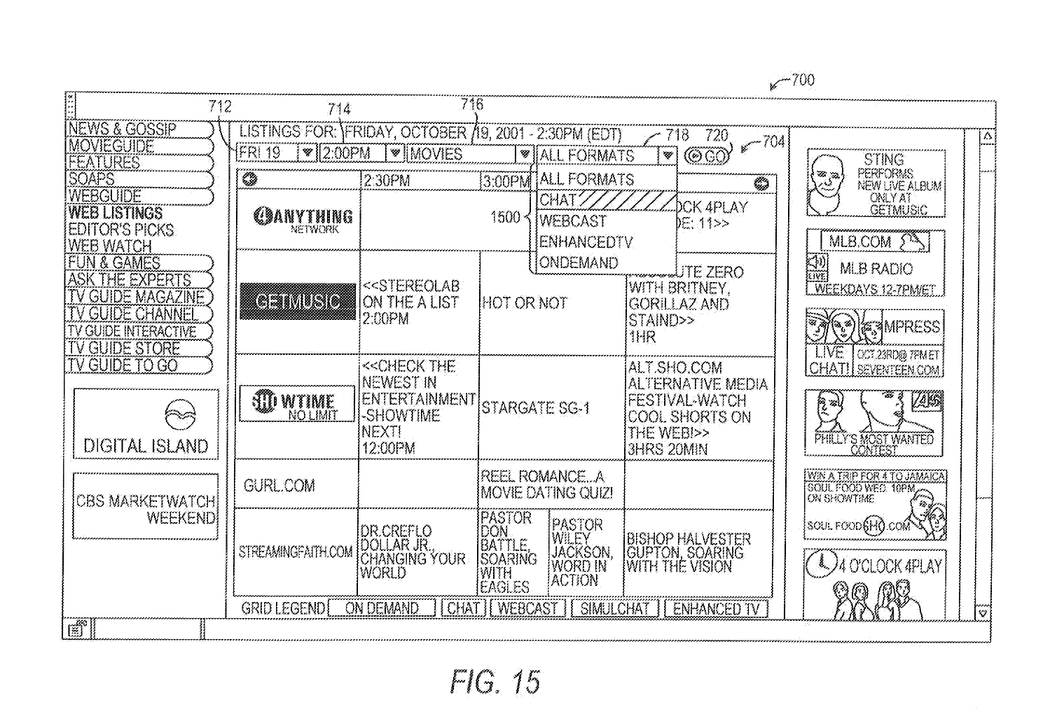

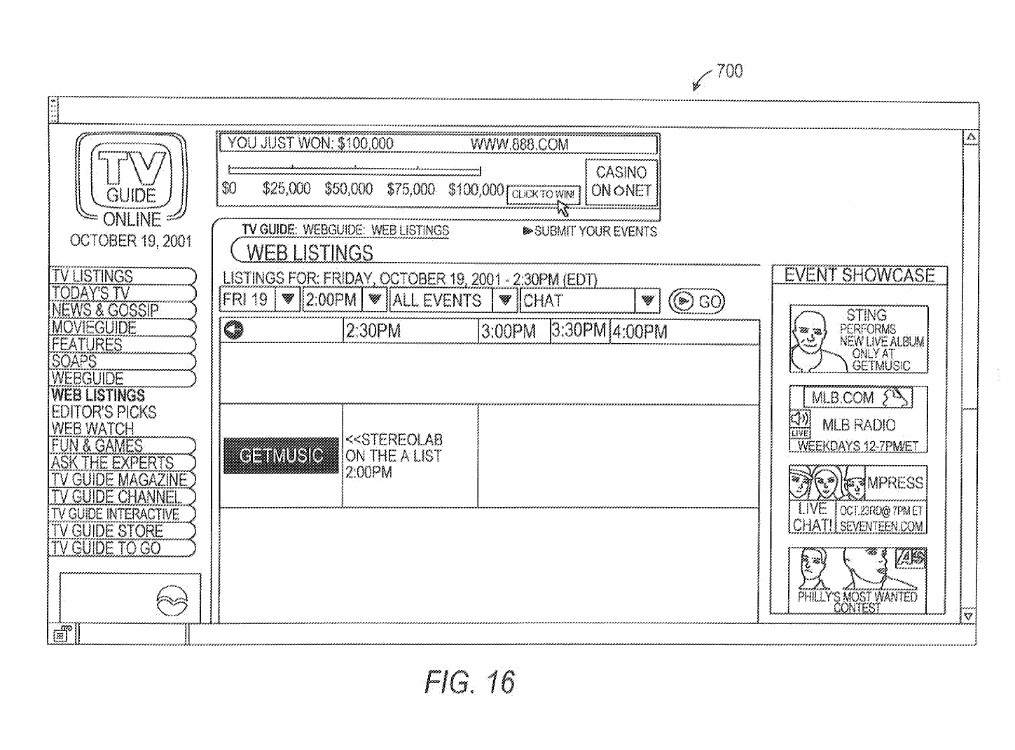

FIG. 15 shows a portion of listings display screen 700 of FIG. 7 after a user has selected format list 718. In response to a user selecting format list 718, the on-line guidance application may provide list 1500 that contains possible formats of on-line events. Possible formats of on-line events may include, for example, all formats of events, chat sessions, simulchats, Webcasts, enhanced TV, and limited availability on-demand content. The user may select a format from list 1500 to set the format as a parameter with which the guide filters on-line event listings in listings area 704. As shown, the user has selected “chat” from format list 1500. In response to the user's submitting the current parameters by selecting go button 720 at this point in the example, the on-line guidance application may filter the listings in listings area 704 accordingly. FIG. 16 shows listings display screen 700 with listings for on-line events filtered according to the selected parameters (i.e., Chat sessions for all categories of events starting at 2:00 PM on Friday, Oct. 19, 2001).

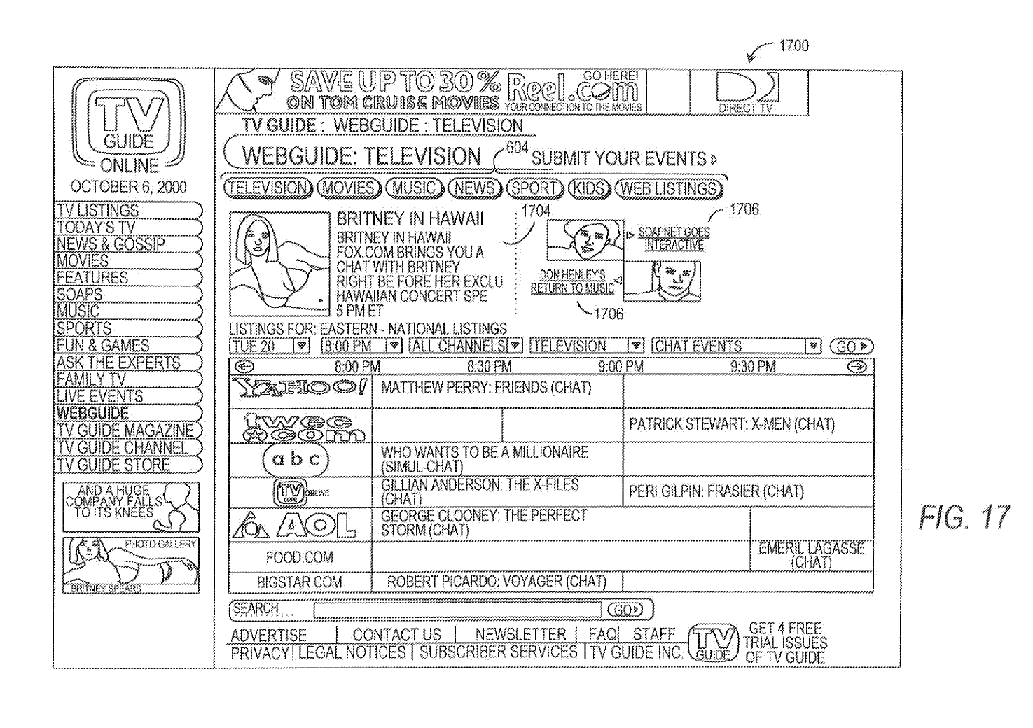

FIG. 17 shows illustrative listings display screen 1700 having listings for on-line events that have been filtered so that display screen 1700 includes listings only for on-line events that are of category “television.” Listings display screen 1700 may be provided by the guide in response to, for example, the user selecting the television category of categories 604 of initial display screen 600 of FIG. 6 or in response to the user filtering listings in listings display screen 900 of FIG. 9 by changing parameter 914 of FIG. 9 to “television.” Listings display screen 1700 is similar to listings display screen 700 of FIG. 7, except it includes selectable informational content 1704 that provides the user with informational content (e.g., text, graphics, audio or video) about on-line events. Listings display screen 1700 also includes selectable links 1706 that, upon selection, provide the user with on-line content that are not events, but rather static content that has no scheduled availability or associated real-time event.

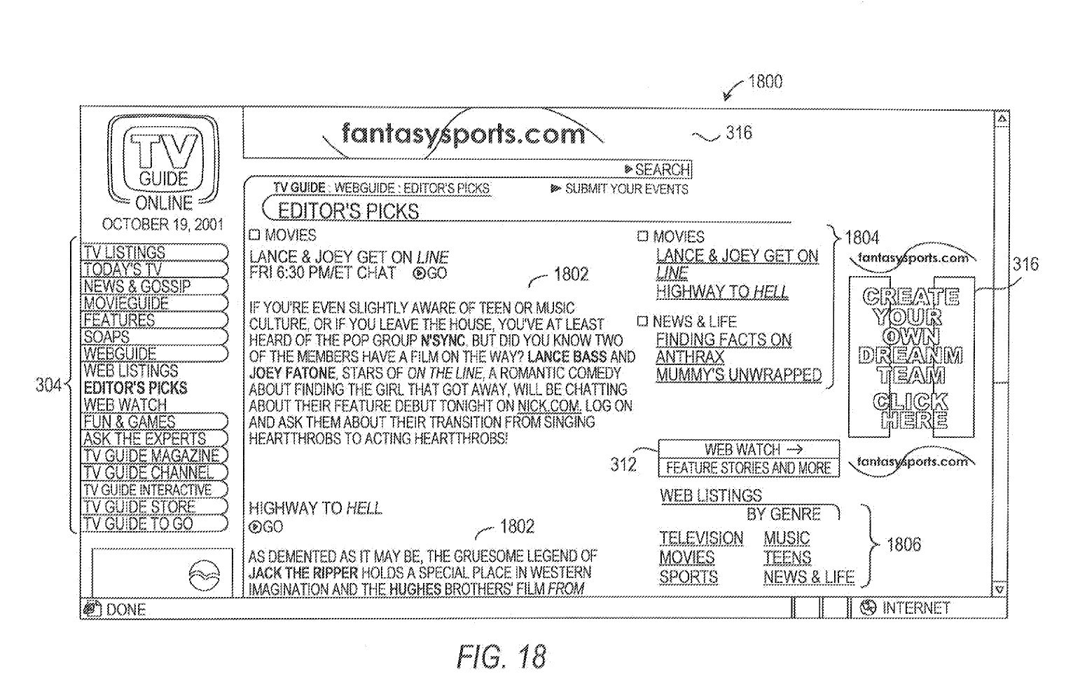

Referring back briefly to FIGS. 3-5, display screen 300 may include editorial content indicators 328. In response to a user selecting an editorial content indicator 328, the guide may display editorial information about on-line events. FIG. 18 shows a portion of illustrative editorial content display screen 1800 that may be provided by the on-line guidance application in accordance with one embodiment of the present invention.

Display screen 1800 may include editorial content 1802. In some embodiments, editorial content 1802 is related to on-line events for which listings are provided (e.g., in listings area 320 of FIG. 4-5, listings area 704 of FIGS. 7-8, or listings area 902 of FIG. 9). Editorial content 1802 may be created by a provider or promoter of the on-line event to which the content is related. Display screen 1800 may include editorial options 1804. In response to the user's selection of one of editorial options 1804, the on-line guidance application may advance display screen 1800 to the portion of display screen 1800 that includes editorial content 1802 related to the selected option.

Display screen 1800 may provide the user with the ability to access other features of the on-line guidance application. For example, display screen 1800 may include Web listings options 1806. In response to the user's selection of a Web listings option 1806, the on-line guidance application may provide a listing display screen with on-line event listings that have been filtered based on the selected genre (i.e., category)

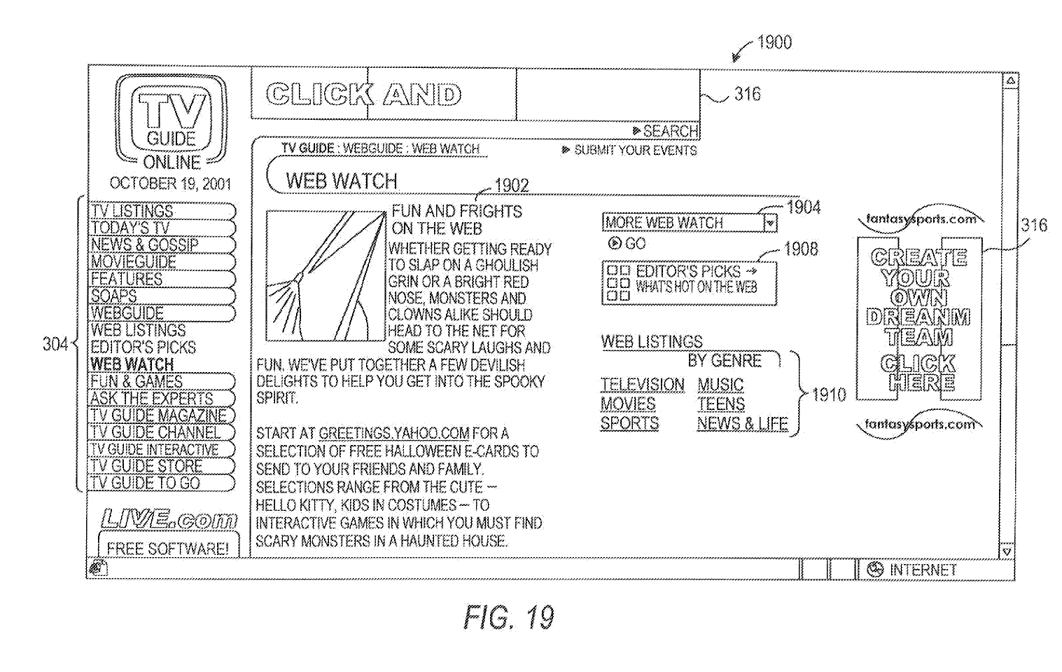

Display screen 1800 and other screens, such as initial display screen 300 of FIGS. 3-5, for example, may include Web Watch option 312. In some embodiments, Web Watch option 312 may include a list of selectable articles relating to on-line delivered content (e.g., as shown in FIG. 3). In other embodiments, Web Watch option 312 may include a selectable icon (e.g., as shown in FIG. 18). In response to the user selecting Web Watch option 312, the guide may provide a display screen having a list of selectable articles relating to on-line delivered content. An illustrative Web Watch display screen 1900 is shown in FIG. 19.

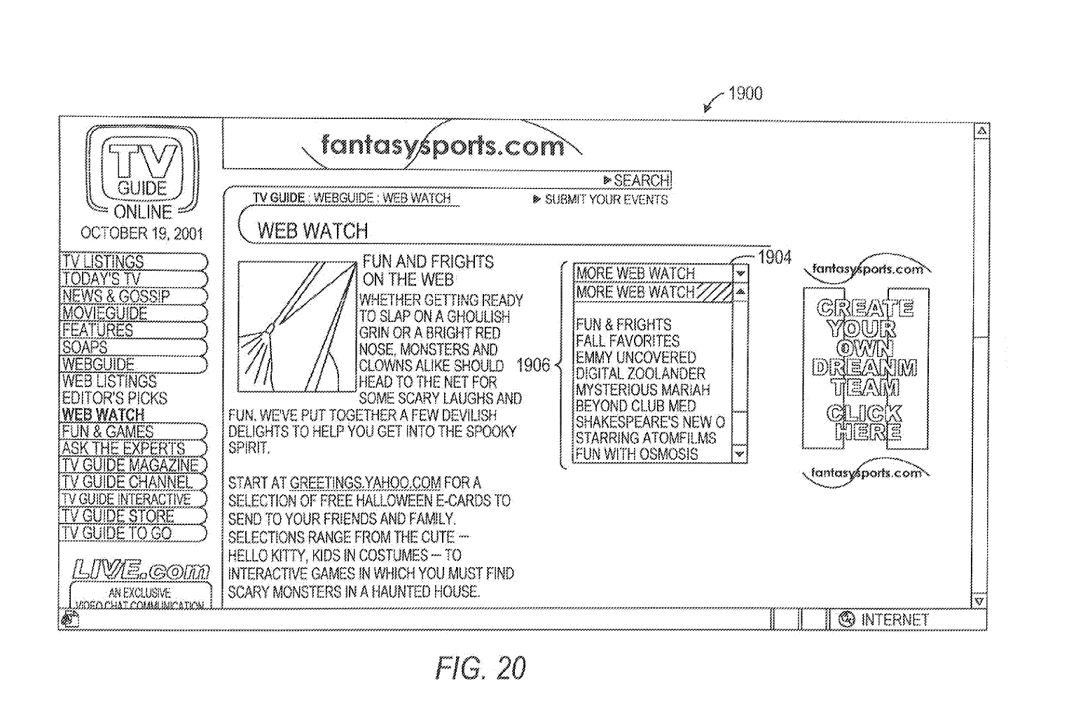

Display screen 1900 may include one or more articles 1902 that are related to on-line delivered content. Article 1902 may include selectable links to access on-line delivered content described in the article. In this example, article 1902 relates to seasonal on-line content (e.g., “Fun and Frights on the Web”). In other examples, article 1902 may be related to entertainment, news, sports, or any other suitable topic. Display screen 1900 may include Web Watch drop-down list 1904. In response to the user's selection of Web Watch drop-down list 1904, the on-line guidance application may provide article list 1906 of available articles, as shown in FIG. 20. The on-line guidance application may provide the user with the ability to select an article from article list 1906 (FIG. 20). In response to the user's selection of an article from article list 1906, the on-line guidance application may display the selected article for the user (not shown).

Referring back to FIG. 19, display screen 1900 may provide the user with the ability to access other features of the on-line guidance application. For example, display screen 1900 may include editor's picks option 1908. In response to the user's selection of editor's picks option 1908, the on-line guidance application may provide a display containing editorial content related to on-line content (such as display 1800 of FIG. 18). The on-line guidance application may also provide Web listings options 1910. In response to the user's selection of a Web listings option 1910, the on-line guidance application may provide a listings display screen that has listings for on-line events filtered based on the genre (i.e., category) that the user selects from Web listings option 1910.

Returning to FIGS. 3-5, the on-line guidance application may provide a provider or promoter of an on-line event with the ability to submit information related to on-line events (e.g., event listings information, editorial information, advertisements, or other suitable information). Display screen 300 may include Submit Your Events feature 326. In response to the provider's selection of feature 326, the on-line guidance application may provide the provider with various user interfaces in connection with submitting information to the on-line guidance application. In such embodiments, the features of event information provider computer 110 (FIG. 1) and Internet and application server 108 (FIG. 1) may be incorporated into a single system for providing an on-line guidance application.

The provider may use, for example, an access device 102 (FIG. 1) to enter event information in displays provided by the guidance application. In response to a provider's submission of event information, the guidance application may retrieve the event information from the submission (e.g., using a suitable script) and incorporate the information into its database of event information. In some of these embodiments, the on-line event information provided by the provider may be reviewed prior to use by the guidance application. For example, the provider's event information may be reviewed for content (e.g., suitable for all audiences), errors (e.g., spelling and grammar), or any other suitable characteristic. In some approaches, software for automatically verifying the content (e.g., spell check, value check, etc.) may be used.

FIG. 21 shows illustrative login box 2102 that may be provided by the on-line guidance application in response to a provider's selection of submit your events feature 326 of display screen 300 (FIG. 3). Login box 2102 may prompt a provider of on-line events for a username, an account ID, and a password in fields 2104, 2106, and 2108, respectively. Alternatively, login box 2102 may prompt a provider for an e-mail address, account ID, and password. Login box 2102 may include login button 2110 that provides the provider with the ability to submit the information contained in fields 2104, 2106, and 2108.

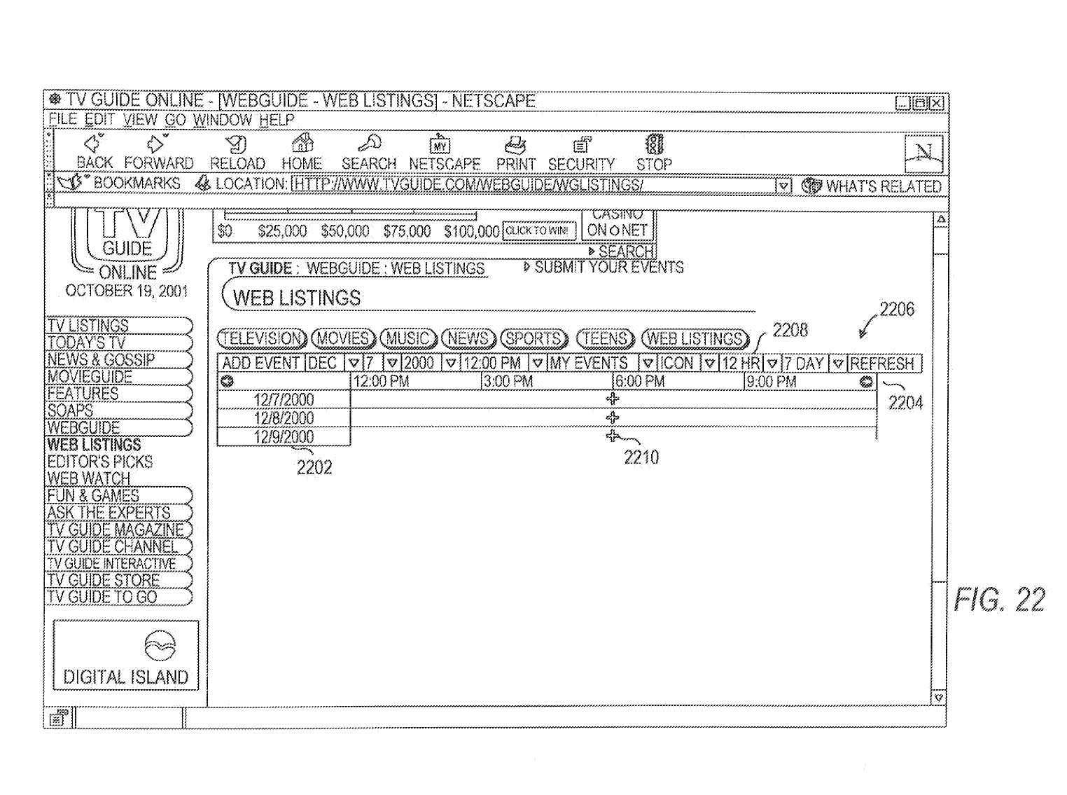

FIG. 22 shows an illustrative event listings review display screen 2200 that may be provided by the on-line guidance application after the provider has logged into the on-line guidance application. Display screen 2200 may provide the provider with the ability to review event information for particular dates 2202 and times 2204 in grid 2206. Display screen 2200 may include parameters 2208. Parameters 2208 may enable the provider to filter the listings that are displayed. For example, the provider may filter listings based on their starting dates, starting times, provider, and how the information is presented (e.g., by an icon or by text). The provider may also control the duration in time region 2204, the duration in date region 2202, or any other suitable parameters in connection with grid 2206. Display screen 2200 may include plus signs 2210 that enable the provider to edit or submit information for an on-line event.

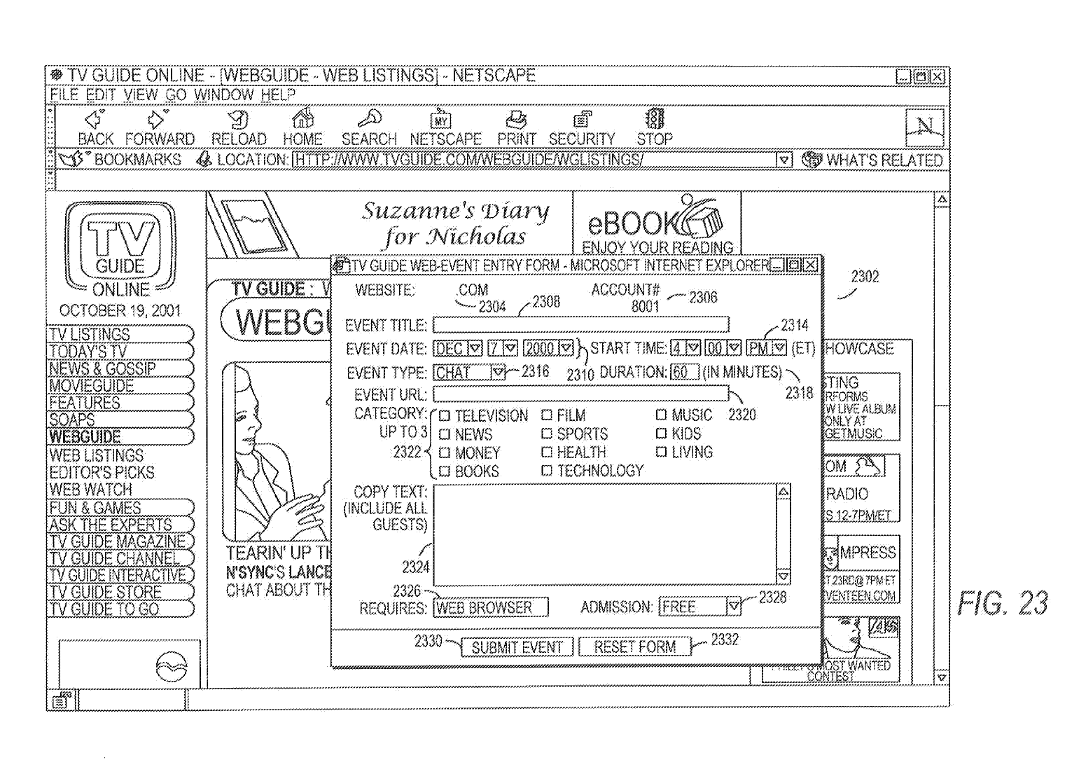

FIG. 23 shows information entry overlay 2302 that may be provided by the on-line guidance application in accordance with one embodiment of the present invention. The guidance application may provide overlay 2302 in response to, for example, the provider selecting a plus sign 2210 of FIG. 22. Information entry overlay 2302 enables a provider of on-line events to enter information in connection with an on-line event. In this example, overlay 2302 includes, among other things, Web site field 2304 and account number field 2306. Web site field 2304 may be prefilled with a Web site URL for the provider. Account number field 2306 may be prefilled with the provider's account number.

Overlay 2302 also includes event title field 2308. Event title field 2308 may enable the provider to enter a title for an on-line event. Event date list 2310, event start time list 2314, event format list 2316, and event duration field 2318 may enable the provider to create various parameters (i.e., dates, times, formats and durations) related to the on-line event.

For example, the provider may select a date for the on-line event from event date list 2310. Event date list 2310 may be prefilled based on which plus sign 2210 (FIG. 22) the provider selected. For example, if the provider selected a plus sign in a row corresponding to Dec. 7, 2000, then that date may be prefilled in event date list 2310. The provider may select a start time for the on-line event from event start time list 2314. The provider may enter a duration for the on-line event in event duration field 2318. As shown in this example, the provider has entered a start time of 4:00 PM and a duration of one hour.

The on-line guidance application may enable the provider to select an event format for the provider's on-line event. For example, the provider may select an event format from event format list 2316. Event formats may include, for example, chat, simulchat, Webcast, enhanced TV, on-demand, or any other suitable format of on-line event.

Overlay 2302 may include event URL region 2320, in which the provider may enter the URL for the event. Overlay 2302 may include category region 2322. The provider may select one or more categories from category region 2322 that apply to the provider's on-line event. Overlay 2302 may include event description region 2324. The provider may enter an event description in event description region 2324.

Overlay 2302 may enable the provider of the on-line event to indicate the software required for the on-line event and the admission, if any, for the event. The provider may enter the required software in software field 2326. As shown in this example, the provider has entered “Web browser” as the software required for the on-line event. The provider may select an admission fee for the on-line event from admission list 2328. As shown in this example, the provider has selected “free” from admission list 2328.

After making the desired entries in overlay 2302, the provider may select submit event button 2330. In response, the on-line guidance application may receive the information entered into overlay 2302. Overlay 2302 may also include a reset form button 2332. In response to the provider's selection of reset form button 2332, the entries in overlay 2302 may be deleted. In another suitable approach, the entries in overlay 2302 may be reset to default values in response to the provider's selection of reset form button 2332.

In response to the provider's selection of submit event button 2330, the on-line guidance application may receive the information entered into overlay 2302. After receiving the information entered into overlay 2302, the information may be entered as a listing into a listings area such as listings area 320 of FIGS. 3-5, listings area 704 of FIGS. 7-8, or listings area 902 of FIG. 9. In one embodiment, a provider of the on-line guidance application may review the information entered by the provider of the on-line event prior to placing the information into a listings area of a guide for on-line content. For example, the provider may review the provider's information for content (e.g., suitable for all audiences), grammar, spelling, or any other suitable criteria for reviewing the information.

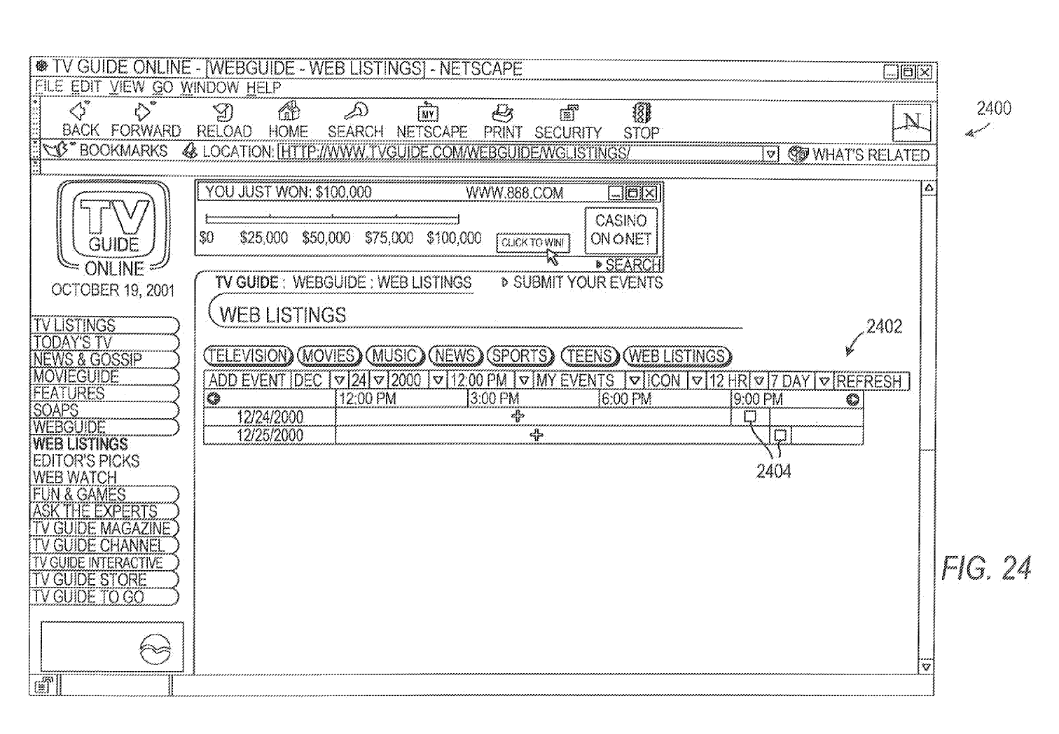

FIG. 24 shows a portion of illustrative provider grid display screen 2400 that may be provided by the on-line guidance application in accordance with one embodiment of the present invention. Provider grid display screen 2400 may be provided in response to the provider's request to view on-line event information for the provider's Web site in icon format.

Display screen 2400 may include grid 2402 that includes the provider's events in icon format. Icons 2404 may represent entries of on-line events made by a provider of on-line events. Such entries may be made, for example, in overlay 2302 of FIG. 23. Icons 2404 may be color-coded to show the status of the on-line event. For example, icons 2404 may be a certain color if the on-line event which it represents is not yet available to users of the on-line guidance application. Icons 2404 may be a different color if the on-line event which it represents is available to users of the on-line guidance application.

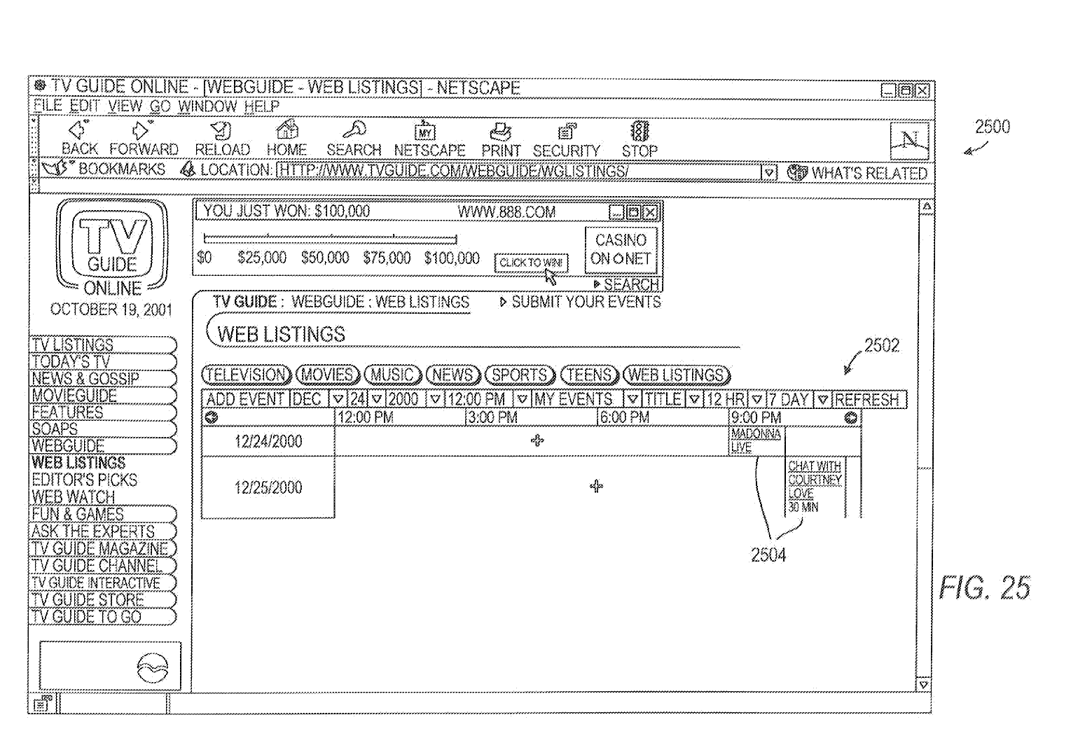

FIG. 25 shows a portion of illustrative provider grid display screen 2500 that may be provided by the on-line guidance application in accordance with one embodiment of the present invention. Provider grid display screen 2500 may be provided in response to the provider's request to view on-line event information for the provider's Web site in title format (e.g., by changing “Icon” parameter 2208 of FIG. 22 to “Title” and selecting “Refresh”).

Display screen 2500 may include grid 2502 that includes the provider's events in title format. Titles 2504 may represent entries of on-line events made by a provider of on-line events. Such entries may be made, for example, in overlay 2300 of FIG. 23. Titles 2504 may be color-coded to show the status of the on-line event. For example, titles 2504 may be a certain color if the on-line event which it represents is not yet available to users of the on-line guidance application. Titles 2504 may be a different color if the on-line event which it represents is available to users of the on-line guidance application.

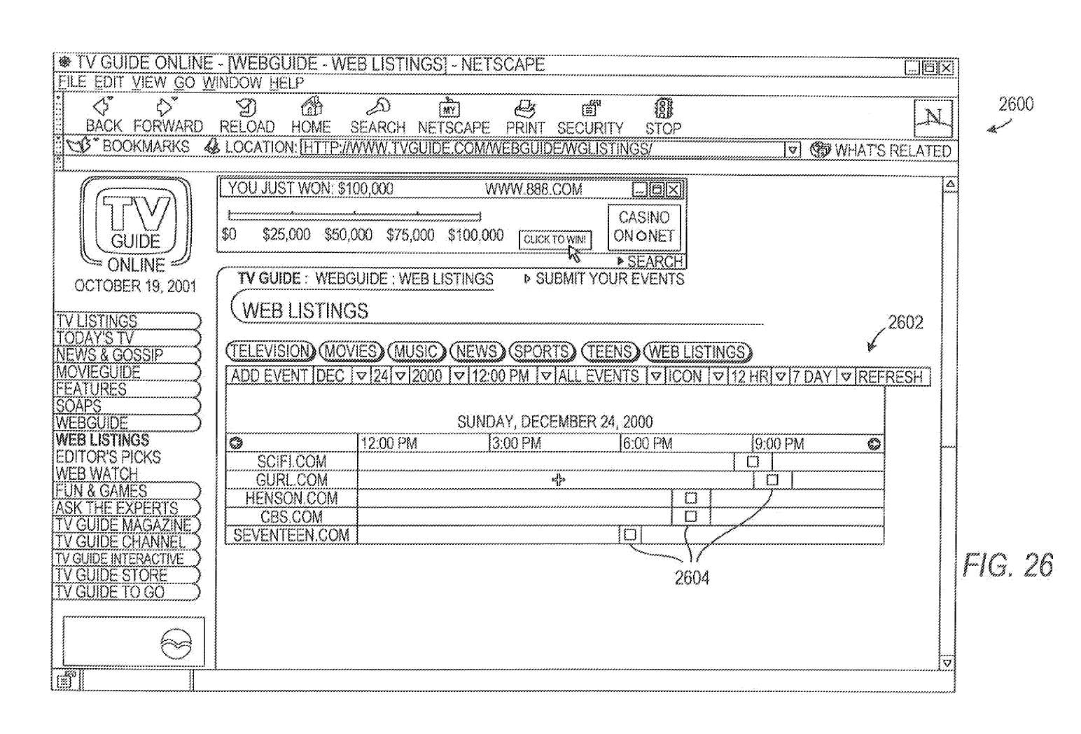

FIG. 26 shows a portion of illustrative all-providers grid display screen 2600 that may be provided by the on-line guidance application in accordance with one embodiment of the present invention. All-providers grid display screen 2600 may be provided in response to the provider's request to view on-line event information for the Web sites of all providers in icon format (e.g., by changing “My Events” parameter 2208 of FIG. 22 to “All Events” and selecting “Refresh”). “All providers” may include the providers that are registered to submit events to the on-line guidance application.

Display screen 2600 may include grid 2602 that includes all providers' events in icon format. Icons 2604 may represent entries of on-line events made by providers of on-line events. Such entries may be made, for example, in overlay 2302 of FIG. 23. Icons 2604 may be color-coded to show the status of the on-line event. For example, icons 2604 may be a certain color if the on-line event which it represents is not yet available to users of the on-line guidance application. Icons 2604 may be a different color if the on-line event which it represents is available to users of the on-line guidance application.

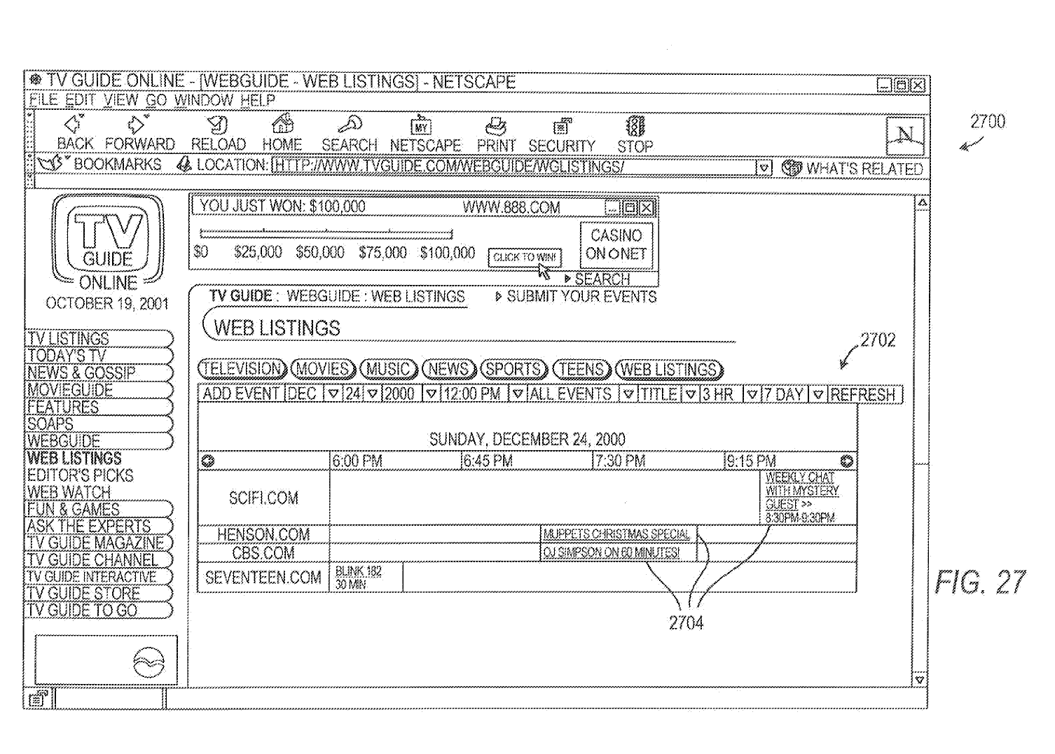

FIG. 27 shows a portion of illustrative all-providers grid display screen 2700 that may be provided by the on-line guidance application in accordance with one embodiment of the present invention. All-providers grid screen 2700 may be provided in response to a provider's request to view on-line event information for the Web sites of all registered providers in title format (e.g., by changing “Icon” parameter 2602 of FIG. 26 to “Title” and selecting “Refresh”).

All-providers grid screen 2700 may include grid 2702 that includes all providers' events in title format. Titles 2704 may represent entries of on-line events made by providers of on-line events. Such entries may be made, for example, in overlay 2302 of FIG. 23. Titles 2704 may be color-coded to show the status of the on-line event. For example, titles 2704 may be a certain color if the on-line event which it represents is not yet available to users of the on-line guidance application. Titles 2704 may be a different color if the on-line event which it represents is available to users of the on-line guidance application.

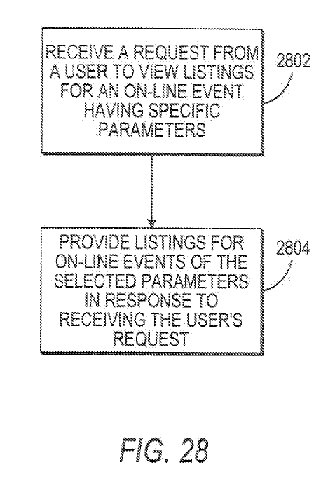

FIG. 28 shows a flow chart of illustrative steps involved in providing filtered listings for on-line events. At step 2802, the on-line guidance application receives a request from a user to view one or more listings for an on-line event having specific parameters. An example of step 2802 is illustrated by the user selecting parameters from lists 712, 714, 716 and 718 of FIGS. 11-16. The on-line guidance application may receive the user's parameter selection in response to the user's selection of go button 720 (FIGS. 11-16). Similar filtering may be performed by the user within, for example, listings display screen 900 of FIG. 9. At step 2804, the on-line guidance application may provide listings for on-line events of the selected parameters. An example of step 2804 is shown in listings display screen 700 of FIG. 16 and listings display screen 1700 of FIG. 17.

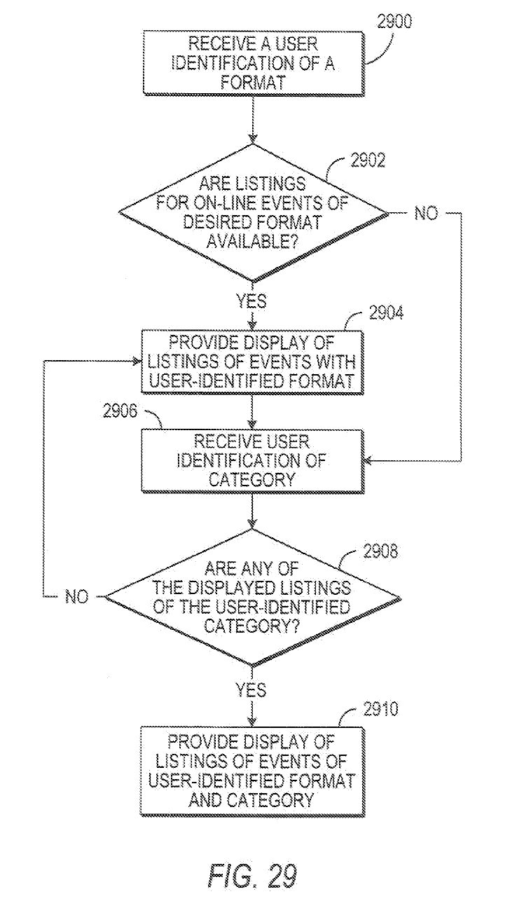

FIG. 29 shows a more detailed flow chart of illustrative steps involved in providing on-line event listings for events filtered based on two parameters—format and category. At step 2900, the guidance application may receive a user indication of a format. An example of step 2900 is illustrated by format drop-down list 718 of FIG. 15. In the example of format drop-down list 718 of FIG. 15, the user has selected the chat session format. At step 2902, the guidance application may determine whether there are on-line event listings of the user-specified format available. If not, the guidance application may receive a user-specified category (step 2906). If so, the guidance application may provide a display of on-line event listings of the user-specified format (step 2904). An example of step 2904 is illustrated by listings display screen 700 of FIG. 16. In display screen 700 of FIG. 16, the only event listings shown are those for chat sessions.

At step 2906, the guidance application may receive a user-specified category. An example of step 2906 is illustrated in category drop-down list 716 of FIG. 13. As shown by drop-down list 716, the user has selected movies from the list. At step 2908, the guidance application may determine whether there are on-line event listings of the user-specified category (e.g., movies) available. If not, the guidance application may provide a display of listings of events having the user-identified format if they are available (step 2904). If so, the guidance application may provide a display of on-line event listings of the user-specified format and category (step 2910). An example of step 2910 is illustrated by listings display screen 700 of FIG. 14.

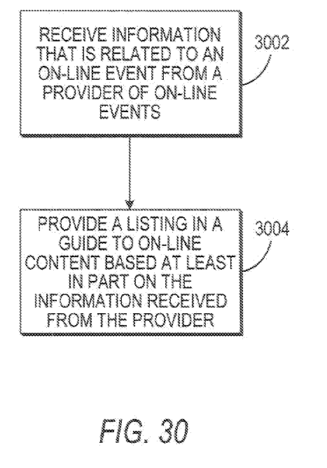

FIG. 30 shows a flow chart of illustrative steps involved in receiving information from a provider of on-line events. At step 3002, an on-line guidance application may receive information that is related to an on-line event from a provider of on-line events. An example of step 3002 is shown in overlay 2302 of FIG. 23. In overlay 2302 of FIG. 23, a provider may enter information in connection with a specific on-line event. In response to the provider's selection of submit event button 2330 (FIG. 23), the on-line guidance application may receive the provider's information in connection with the on-line event. At step 3004, the on-line guidance application may provide a listing in a guide to on-line content based at least in part on the information received from the provider. An example of step 3004 is shown in listings area 320 of FIGS. 3-5, listings area 704 of FIGS. 7-8, and listings area 902 of FIG. 9.

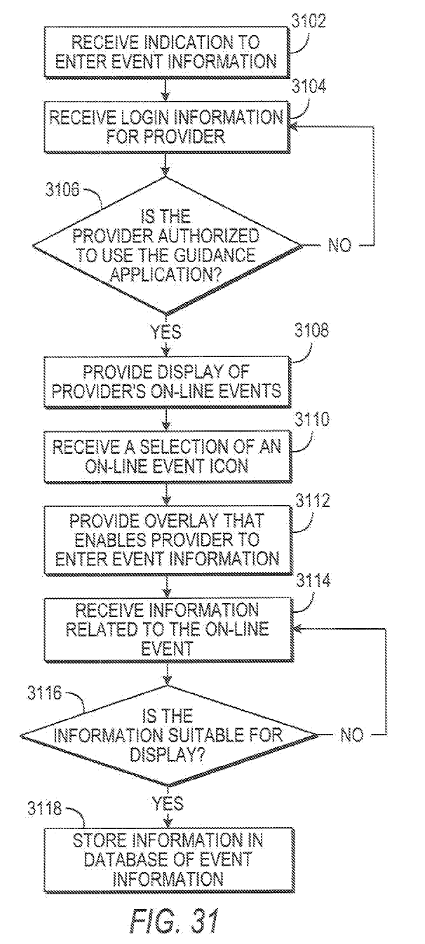

FIG. 31 is a flow chart of illustrative additional steps involved in receiving information from a provider of on-line events. At step 3102, an on-line guidance application may receive an indication that a provider of on-line events wishes to enter event information. At step 3104, the on-line guidance application may receive login information for the provider of on-line events. An illustrative example of step 3104 is shown in FIG. 21. At step 3106, the on-line guidance application may determine if the provider is authorized to use the guidance application. If not, the on-line guidance application may again receive login information from the provider (step 3104). In some embodiments, the on-line guidance application may limit the number of login attempts made by the provider. If it is determined that the provider is authorized to use the guidance application, the on-line guidance application may provide a display having the provider's on-line events listed (step 3108). An illustrative example of step 3108 is shown in display screen 2200 of FIG. 22.

At step 3110, the on-line guidance application may receive a selection of an on-line event icon. An example of such an icon may be plus sign 2210 of FIG. 22. At step 3112, the on-line guidance application may provide an overlay that enables the provider to enter event information. An illustrative example of step 3112 is shown in overlay 2302 of FIG. 23. At step 3114, the on-line guidance application may received information related to the on-line event. Such information may include, for example, event title, event date, event start time, event format, event duration, event URL, event category, event description, software requirements, event admission, or any other suitable event information. At step 3116, the on-line guidance application may determine if the information is suitable for display to a user of the on-line guidance application. For example, the event information may be reviewed for content, grammar, or any other suitable criteria. If the information is not suitable for display, the on-line guidance application may again receive information related to the on-line event (step 3114). If the information is suitable for display, the on-line guidance application may store the information in a database of event information (step 3118).

Thus, systems and methods for providing a guide to on-line events are provided. One skilled in the art will realize that the present invention can be practiced by other than the described embodiments, which are presented for purposes of illustration and not of limitation, and that the present invention is limited only by the claims which follow.

1. A method for providing listings for on-line events in an on-line guidance application, comprising:
receiving from an access device associated with a user a request to provide listings for on-line events of a user-specified format, wherein on-line event content comprises scheduled Internet-delivered content; and
providing to the access device one or more listings of on-line events that have the user-specified format in response to receiving the request.

2. The method of claim 1 further comprising:
receiving from the access device a request to provide listings for on-line events of a user-specified category; and
providing to the access device one or more listings of on-line events that have the user-specified category in response to receiving the request.

3. The method of claim 1 wherein providing to the access device the one or more listings comprises providing a Web page that, when displayed by the access device, displays the one or more listings in a color associated with the user-defined format.

4. The method of claim 1 wherein providing to the access device the one or more listings comprises providing a Web page that, when displayed by the access device, indicates a provider for each of the one or more listings using a graphical indicator.

5. The method of claim 1 further comprising:
receiving from the access device a request to provide information related to a user-identified on-line event; and
providing to the access device information related to the user-identified on-line event in response to receiving the request.

6. The method of claim 5 wherein the information related to the user-identified on-line event is an event title, an event Web site, an event description, an event date, an event time, an event duration, an event admission fee, an event format, or a specification of necessary software.

7. The method of claim 1 further comprising:
receiving from the access device a request to provide listings for on-line events occurring on a user-specified date; and
providing to the access device one or more listings of on-line events that occur on the user-specified date in response to receiving the request.

8. The method of claim 1 further comprising:
receiving from the access device a request to provide listings for on-line events occurring at a user-specified time; and
providing to the access device one or more listings of on-line events that occur at the user-specified time in response to receiving the request.

9. A method for receiving and providing information related to on-line events in an on-line guidance application, comprising:
providing a provider of an on-line event with an opportunity to enter information related to the on-line event using a computer associated with the provider, wherein the information related to the on-line event comprises at least an indication of a format of the on-line event, and wherein on-line event content comprises scheduled Internet-delivered content;
receiving the information related to the on-line event from the computer;
receiving from an access device associated with a user an indication comprising at least a user-specified format to provide the information related to the on-line event; and
providing the information related to the on-line event to the access device in response to receiving the indication.

10. The method of claim 9 wherein providing a provider of an on-line event with an opportunity to enter information comprises providing the provider with an opportunity to enter an event format.

11. The method of claim 9 wherein providing a provider of an on-line event with an opportunity to enter information comprises providing the provider with an opportunity to enter an event admission fee.

12. The method of claim 9 wherein providing a provider of an on-line event with an opportunity to enter information comprises providing the provider with an opportunity to enter an event category.

13. The method of claim 9 wherein providing a provider of an on-line event with an opportunity to enter information comprises providing the provider with an opportunity to enter a specification for software that is necessary to access the on-line event.

14. The method of claim 9 further comprising:
receiving from the computer a request to provide listings for the provider's on-line events; and
providing to the computer the listings for the provider's on-line events in response to receiving the request.

15. The method of claim 9 further comprising:
receiving from the computer a request to provide listings for on-line events associated with a plurality of providers; and
providing to the computer the listings for the on-line events associated with the plurality of providers in response to receiving the request.

16. A system for providing listings for on-line events in an on-line guidance application, comprising:
means for receiving from an access device associated with a user a request to provide listings for on-line events of a user-specified format, wherein on-line event content comprises scheduled Internet-delivered content; and
means for providing to the access device one or more listings of on-line events that have the user-specified format in response to receiving the request.

17. The system of claim 16 further comprising:
means for receiving from the access device a request to provide listings for on-line events of a user-specified category; and
means for providing to the access device one or more listings of on-line events that have the user-specified category in response to receiving the request.

18. The system of claim 16 wherein the means for providing to the access device the one or more listings comprises means for providing a Web page that, when displayed by the access device, displays the one or more listings in a color associated with the user-defined format.

19. The system of claim 16 wherein the means for providing to the access device the one or more listings comprises means for providing a Web page that, when displayed by the access device, indicates a provider for each of the one or more listings using a graphical indicator.

20. The system of claim 16 further comprising:
means for receiving from the access device a request to provide information related to a user-identified on-line event; and
means for providing to the access device information related to the user-specified on-line event in response to receiving the request.

21. The system of claim 20 wherein the information related to the user-specified on-line event is an event title, an event Web site, an event description, an event date, an event time, an event duration, an event admission fee, an event format, or a specification of necessary software.

22. The system of claim 16 further comprising:
means for receiving from the access device a request to provide listings for on-line events occurring on a user-specified date; and
means for providing to the access device one or more listings of on-line events that occur on the user-specified date in response to receiving the request.

23. The system of claim 16 further comprising:
means for receiving from the access device a request to provide listings for on-line events occurring at a user-specified time; and
means for providing to the access device one or more listings of on-line events that occur at the user-specified time in response to receiving the request.

24. A system for receiving and providing information related to on-line events in an on-line guidance application, comprising:
means for providing a provider of an on-line event with an opportunity to enter information related to the on-line event, using a computer associated with the provider, wherein the information related to the on-line event comprises at least an indication of a format of the on-line event, and wherein on-line event content comprises scheduled Internet-delivered content;
means for receiving the information related to the on-line event from the computer;
means for receiving from an access device associated with a user an indication comprising at least a user-specified format to provide the information related to the on-line event; and
means for providing the information related to the on-line event to the access device in response to receiving the indication.

25. The system of claim 24 wherein the means for providing a provider of an on-line event with an opportunity to enter information comprises means for providing the provider with an opportunity to enter an event format.

26. The system of claim 24 wherein the means for providing a provider of an on-line event with an opportunity to enter information comprises providing the provider with an opportunity to enter an event admission fee.

27. The system of claim 24 wherein the means for providing a provider of an on-line event with an opportunity to enter information comprises means for providing the provider with an opportunity to enter an event category.

28. The system of claim 24 wherein the means for providing a provider of an on-line event with an opportunity to enter information comprises means for providing the provider with an opportunity to enter a specification for software that is necessary to access the on-line event.

29. The system of claim 24 further comprising:
means for receiving from the computer a request to provide listings for the provider's on-line events; and
means for providing to the computer the listings for the provider's on-line events in response to receiving the request.

30. The system of claim 24 further comprising:
means for receiving from the computer a request to provide listings for on-line events associated with a plurality of providers; and
means for providing to the computer the listings for the on-line events associated with the plurality of providers in response to receiving the request.

31. Computer-readable media for an on-line guidance application, wherein the media is encoded with machine-readable instructions for performing the method comprising:
receiving from an access device associated with a user a request to provide listings for on-line events of a user-specified format, wherein on-line event content comprises scheduled Internet-delivered content; and
providing to the access device one or more listings of on-line events that have the user-specified format in response to receiving the request.

32. The computer-readable media of claim 31 wherein the method further comprises:
receiving from the access device a request to provide listings for on-line events of a user-specified category; and
providing to the access device one or more listings of on-line events that have the user-specified category in response to receiving the request.

33. The computer-readable media of claim 31 wherein providing to the access device the one or more listings comprises providing a Web page that, when displayed by the access device, displays the one or more listings in a color associated with the user-defined format.

34. The computer-readable media of claim 31 wherein providing to the access device the one or more listings comprises providing a Web page that, when displayed by the access device, indicates a provider for each of the one or more listings using a graphical indicator.

35. The computer-readable media of claim 31 wherein the method further comprises:
receiving from the access device a request to provide information related to a user-identified on-line event; and
providing to the access device information related to the user-identified on-line event in response to receiving the request.

36. The computer-readable media of claim 35 wherein the information related to the user-identified on-line event is an event title, an event Web site, an event description, an event date, an event time, an event duration, an event admission fee, an event format, or a specification of necessary software.

37. The computer-readable media of claim 31 wherein the method further comprises:
receiving from the access device a request to provide listings for on-line events occurring on a user-specified date; and
providing to the access device one or more listings of on-line events that occur on the user-specified date in response to receiving the request.

38. The computer-readable media of claim 31 wherein the method further comprises:
receiving from the access device a request to provide listings for on-line events occurring at a user-specified time; and
providing to the access device one or more listings of on-line events that occur at the user-specified time in response to receiving the request.

39. Computer-readable media for an on-line guidance application, wherein the media is encoded with machine-readable instructions for performing the method comprising:
providing a provider of an on-line event with an opportunity to enter information related to the on-line event using a computer associated with the provider, wherein the information related to the on-line event comprises at least an indication of a format of the on-line event and, wherein on-line event content comprises scheduled Internet-delivered content;
receiving the information related to the on-line event from the computer;
receiving from an access device associated with a user an indication comprising at least a user-specified format to provide the information related to the on-line event; and
providing the information related to the on-line event to the access device in response to receiving the indication.

40. The computer-readable media of claim 39 wherein providing a provider of an on-line event with an opportunity to enter information comprises providing the provider with an opportunity to enter an event format.

41. The computer-readable media of claim 39 wherein providing a provider of an on-line event with an opportunity to enter information comprises providing the provider with an opportunity to enter an event admission fee.

42. The computer-readable media of claim 39 wherein providing a provider of an on-line event with an opportunity to enter information comprises providing the provider with an opportunity to enter an event category.

43. The computer-readable media of claim 39 wherein providing a provider of an on-line event with an opportunity to enter information comprises providing the provider with an opportunity to enter a specification for software that is necessary to access the on-line event.

44. The computer-readable media of claim 39 wherein the method further comprises:
receiving from the computer a request to provide listings for the provider's on-line events; and
providing to the computer the listings for the provider's on-line events in response to receiving the request.

45. The computer-readable media of claim 39 wherein the method further comprises:
receiving from the computer a request to provide listings for on-line events associated with a plurality of providers; and
providing to the computer the listings for the on-line events associated with the plurality of providers in response to receiving the request.

46. A system for providing listings for on-line events in an on-line guidance application, the system comprising:
an access device associated with a user; and
an on-line guidance application implemented at least partially on an Internet and application server and programmed to:
receive a request to provide listings for on-line events of a user-specified format from the access device, wherein on-line event content comprises scheduled Internet-delivered content; and
in response to receiving the request, provide one or more listings of on-line events that have the user-specified format to the access device.

47. The system of claim 46 wherein the on-line guidance application is further programmed to:
receive a request to provide listings for on-line events of a user-specified category from the access device; and
in response to receiving the request, provide one or more listings of on-line events that have the user-specified category to the access device.

48. The system of claim 46 wherein the one or more listings are provided on a Web page that, when displayed by the access device, displays the one or more listings in a color associated with the user-defined format.

49. The system of claim 46 wherein the one or more listings are provided on a Web page that, when displayed by the access device, indicates a provider for each of the one or more listings using a graphical indicator.

50. The system of claim 46 wherein the on-line guidance application is further programmed to:
receive a request to provide information related to a user-identified on-line event from the access device; and
in response to receiving the request, provide information related to the user-identified on-line event to the access device.

51. The system of claim 50 wherein the information related to the user-identified on-line event is an event title, an event Web site, an event description, an event date, an event time, an event duration, an event admission fee, an event format, or a specification of necessary software.

52. The system of claim 46 wherein the on-line guidance application is further programmed to:
receive a request to provide listings for on-line events occurring on a user-specified date from the access device; and
in response to receiving the request, provide one or more listings of on-line events that occur on the user-specified date to the access device.

53. The system of claim 46 wherein the on-line guidance application is further programmed to:
receive a request to provide listings for on-line events occurring at a user-specified time from the access device; and
in response to receiving the request, provide one or more listings of on-line events that occur at the user-specified time to the access device.

54. A system for receiving and providing information related to on-line events in an on-line guidance application, the system comprising:
a computer associated with a provider of an on-line event;
an access device associated with a user; and
an on-line guidance application implemented at least partially on an Internet and application server and programmed to:
provide the provider of the on-line event with an opportunity to enter information related to the on-line event using the computer, wherein the information related to the on-line event comprises at least an indication of a format of the on-line event, and wherein on-line event content comprises scheduled Internet-delivered content;
receive the information related to the on-line event from the computer;
receive an indication comprising at least a user-specified format to provide the information related to the on-line event from the access device; and
in response to receiving the indication, provide the information related to the on-line event to the access device.

55. The system of claim 54 wherein the information entered by the provider is an event format.

56. The system of claim 54 wherein the information entered by the provider is an event admission fee.

57. The system of claim 54 wherein the information entered by the provider is an event category.

58. The system of claim 54 wherein the information that is entered by the provider is a specification for software that is necessary to access the on-line event.

59. The system of claim 54 wherein the on-line guidance application is further programmed to:
receive a request to provide listings for the provider's on-line events from the computer; and
in response to receiving the request, provide the listings for the provider's on-line events to the computer.

60. The system of claim 54 wherein the on-line guidance application is further programmed to:
receive a request to provide listings for on-line events associated with a plurality of providers from the computer; and
in response to receiving the request, providing the listings for the on-line events associated with the plurality of providers to the computer.
